(19) United States
(12) Patent Application Publication
(10) Pub. No.: US 2004/0059049 A1
(43) Pub. Date: Mar. 25, 2004

(54) Fuse of an organosilicon compound bearing at least an activated double ethylene bond as coupling agent in rubber compositions comprising a white filler

(76) Inventors: Pierre Barruel, Tassin la Demi-Lune (FR); Nathalie Guennouni, Irigny (FR); Herve Parisot, Wette Fays, Caluire (FR); Jean-Claude Tardivat, Clermont-Ferrand (FR)

Correspondence Address: BURNS DOANE SWECKER & MATHIS L L P, POST OFFICE BOX 1404, ALEXANDRIA, VA, 22313-1404, US

(21) Appl. No.: 10/311,542

(22) PCT Filed: Jun. 14, 2001
(86) PCT No.: PCT/FR01/01856

(30) Foreign Application Priority Data
Jun. 16, 2000 (FR) 00/07696

(51) Int. Cl. C08L 83/00

(52) U.S. Cl. 524/588

(57) ABSTRACT

The field of the present invention is that of the use of a compound comprising a polyfunctional polyorganosiloxane (abbreviated as POS) bearing, firstly, at least one hydroxyl radical and/or at least one alkoxy radical and, secondly, at least one activated ethylenic double bond, as a coupling agent (elastomeric white filler) in rubber compositions based on isoprene elastomer(s) comprising a white filler as reinforcing filler. The invention also relates to the isoprene elastomer compositions obtained by using the said coupling agent, and to elastomeric articles with a body comprising the abovementioned compositions.

The coupling agent is especially a compound which comprises a POS containing identical or different units of formula:

$$\begin{matrix}{( {R}^{2} )}_{a} {Y}_{b} {X}_{c} SiO & \\ & \frac{4 - ( a + b + c )}{2}\end{matrix} \qquad ( I )$$

in which (1) R² is a monovalent hydrocarbon-based group; (2) Y represents an OH or an alkoxy; (3) X is a function comprising an activated ethylenic double bond chosen in particular from a maleimide, an isomaleimide, a maleamic acid, a maleamic ester and an acrylamide function; (4) a=0, 1, 2 or 3, b=0, 1, 2 or 3 and c=0 or 1, the sum a+b+c is other than 0 and ≦3; (5) the content of function Y is ≧0.8%; (6) the content of functions X is ≧0.4% (content=number of functions per 100 Si atoms).

The field of the present invention is that of the use of a compound comprising a polyfunctional polyorganosiloxane (abbreviated as POS) bearing at least one activated ethylenic double bond, as a coupling agent (elastomeric white filler) in rubber compositions comprising a white filler as reinforcing filler. The invention also relates to the elastomer compositions obtained by using the said coupling agent, and to elastomeric articles with a body comprising the abovementioned compositions.

The types of elastomeric articles for which the invention is most useful are those that are especially subject to the following constraints: large temperature variations and/or large variations in dynamic frequency stress; and/or a large static stress and/or a large dynamic bending fatigue. Examples of types of articles include: conveyor belts, power transmission belts, flexible tubes, expansion joints, seals on household electrical appliances, supports acting as engine vibration extractors either with metallic armouring or with a hydraulic fluid inside the elastomer, cables, cable sheaths, shoe soles and rollers for cable cars.

The field of the invention is that of an efficient use capable of providing elastomer compositions which have in particular: for great ease of use of the raw blends prepared, in particular as regards extrusion and calendering operations, rheological properties that are marked by the lowest possible viscosity values; to achieve excellent production efficiency for the vulcanization installation, the shortest possible vulcanization times; and to satisfy the implementation constraints mentioned above, excellent reinforcing properties imparted by a filler, in particular optimum values of tensile elastic modulus, of tensile breaking strength and of abrasion resistance.

To achieve such an objective, many solutions have been proposed, which are ess ntially based on the use of elastomer(s) modified with a reinforcing filler. It is generally known that, in order to obtain the optimum reinforcing properties imparted by a filler, this filler should be present in the elastomer matrix in a final form which is both as finely divided as possible and distributed as uniformly as possible. However, such conditions can only be achieved if the filler has a very good capacity firstly to be incorporated into the matrix during the mixing with the elastomer(s) and to de-aggregate, and secondly to be uniformly dispersed in the elastomer matrix.

In a known manner, carbon black is a filler which has such capacities, but this is not generally the case for white fillers. The use of white reinforcing filler alone, in particular reinforcing silica alone, is found to be unsuitable on account of the poor level of certain properties of such compositions and consequently of certain properties of articles using these compositions. For reasons of mutual affinities, white filler particles, in particular silica particles, have an annoying tendency to aggregate together in the elastomer matrix. These filler/filler interactions have the harmful consequence of limiting the dispersion of the filler and thus of limiting the reinforcing properties to a level which is substantially lower than that which it would theoretically be possible to reach if all the bonds (white filler-elastomer) capable of being created during the mixing operation were indeed obtained. What is more, these interactions also tend to increase the viscosity of the elastomer compositions in the raw state, and thus to make them more difficult to use than in the presence of carbon black.

It is known by those skilled in the art that it is necessary to use a coupling agent, also known as a binder, whose function is to provide the connection between the surface of the particles of white filler and the elastomer, while at the same time making this white filler disperse more easily in the elastomer matrix.

In a known manner, the term “coupling agent” (for white filler-elastomer coupling) means an agent capable of establishing a sufficient connection, of chemical and/or physical nature, between the white filler and elastomer; such a coupling agent, which is at least bifunctional, has for example the simplified general formula “Y-G-X”, in which:

Y represents a functional group (function Y) which is capable of physically and/or chemically bonding to the white filler, such a bond possibly being established, for example, between a silicon atom of the coupling agent and the surface hydroxyl (OH) groups of the white filler (for example the surface silanols when the white filler is silica);

X represents a functional group (function X) capable of physically and/or chemically bonding to the elastomer, for example via a sulphur atom;

G represents a hydrocarbon-based group for linking Y and X.

Coupling agents should, in particular, not be confused with simple agents for covering white filler which, in a known manner, may comprise the function Y which is active with respect to the white filler, but lack the function X which is active with respect to the elastomer.

Coupling agents, in particular for silica-elastomer coupling, have been disclosed in a large number of documents, the most well-known being bifunctional alkoxysilanes.

Thus, it has been proposed in patent application FR-A-2 094 859 to use a mercaptosilane to increase the affinity of the silica for the elastomer matrix. It was demonstrated and it is nowadays well known that mercaptosilanes, and in particular γ-mercaptopropyltrimethoxysilane or γ-mercaptopropyltriethoxysilane, are capable of affording excellent silica-elastomer coupling properties, but that the industrial use of these coupling agents is not possible on account of the high reactivity of the —SH functions which leads very quickly, during the preparation of the elastomer composition of rubber type in an internal mixer, to premature vulcanizations, also known as “scorching”, to high viscosities and, finally, to rubber compositions that are virtually impossible to process or to use industrially. To illustrate this impossibility of industrially using such coupling agents and rubber compositions containing them, reference may be made to documents FR-A-2 206 330 and U.S. Pat. No. 4,002,594.

To overcome this drawback, it has been proposed to replace these mercaptosilanes with alkoxysilane polysulphides, in particular bis-tri(C₁-C₄)alkoxysilylpropyl polysulphides as disclosed in many patents and patent applications (see, for example, FR-A-2 206 330, U.S. Pat. No. 3,842,111, U.S. Pat. No. 3,873,489, U.S. Pat. No. 3,978,103 and U.S. Pat. No. 3,997,581). Among these polysulphides, mention will be made in particular of bis(3-triethoxysilylpropyl) tetrasulphide (abbreviated as TESPT), which is generally considered nowadays as the product providing, for silica-filled vulcanizates, the best compromise in terms of safety from scorching, ease of use and reinforcing power, but which has the known drawback of being very expensive (see, for example, patents U.S. Pat. No. 5,652,310, U.S. Pat. No. 5,684,171 and U.S. Pat. No. 5,684,172).

In the light of the prior art, it thus appears that there is an unsatisfied need in efficient uses for coupling agents in elastomer compositions comprising a siliceous material as reinforcing filler or more generally comprising a white reinforcing filler.

The Applicant has discovered in the course of its research that, unexpectedly:

specific coupling agents consisting of a compound comprising a multifunctional POS firstly bearing, as function Y, at least one OH radical and/or at least one hydrolysable radical, and secondly bearing, as function X, at least one group containing an activated ethylenic double bond,

offer coupling performance qualities that are at least equivalent to those associated with the use of alkoxysilane polysulphides, in particular TESPT, while moreover avoiding the problems of scorching, as well as the problems of implementation associated with an excessive viscosity of rubber compositions in raw form, which are especially intrinsic to mercaptosilanes,

when the said specific coupling agents are used in rubber compositions based on isoprene elastomer(s).

Multifunctional organosilanes (abbreviated as OS) such as, for example, alkoxysilanes bearing an activated ethylenic double bond have already been described as coupling agents (for white filler-elastomer coupling) in rubber compositions (cf. in particular patent application JP-A-64/29385), but these coupling agents have hitherto all shown insufficient coupling performance qualities, which are markedly inferior to those offered by the alkoxysilane polysulphides of the TESPT type.

First Subject of the Invention

Consequently, the present invention, taken in its first subject, relates to the use:

of an effective amount of a coupling agent consisting of a compound A bearing at least two functions, noted Y and X, which is graftable firstly onto the white filler by means of the function Y and secondly onto the elastomer by means of the function X;

as white filler-elastomer coupling agent in rubber compositions comprising:

(B) at least one elastomer of natural or synthetic rubber type;

(C) a white filler as reinforcing filler;

the said use being characterized in that:

the coupling agent is a compound A which comprises a multifunctional POS (compound A_{POS}) comprising, per molecule, and attached to silicon atoms, firstly at least one hydroxyl function and/or at least one hydrolysable function, and secondly at least one group containing an activated ethylenic double bond;

the said coupling agent is incorporated into rubber compositions based on isoprene elastomer(s); and

the amount of the said coupling agent is determined so as to provide in the isoprene rubber composition at least 0.5 pce (parts by weight per 100 parts by weight of elastomer(s)) of POS (compound A_{POS}).

The coupling agent (compound A_{POS}) used in the present invention has the essential characteristic of being a POS bearing at least one activated ethylenic double bond (function X) allowing it to be grafted onto the isoprene elastomer. In a known manner, the term “activated” bond means a bond which has been made more capable of reacting (in the present case, with the isoprene elastomer). Needless to say, like any other coupling agent (for white filler-isoprene elastomer coupling), it also bears a second functionality (function Y) allowing it to be grafted onto the white reinforcing filler, consisting, for example, of at least one ≡Si—OH function and/or at least one ≡Si-alkoxy hydrolysable function.

As regards the functionality X, each ethylenic double bond is preferably activated by the presence of at least one adjacent electron-withdrawing group, that is to say a group attached to at least one of the two carbon atoms of the ethylenic double bond. It is recalled that, by definition, an “electron-withdrawing” group is a radical or functional group capable of withdrawing the electrons towards itself more than a hydrogen atom would do if it occupied the same place in the molecule under consideration.

This electron-withdrawing or “activating” group is preferably chosen from radicals bearing at least one of the bonds C═O, C═C, C≡C, OH, OR (R alkyl), CN or OAr (Ar aryl), or bearing at least one sulphur and/or nitrogen atom or at least one halogen.

Mention will be made more preferably of an activating group chosen from acyl (—COR), carbonyl (>C═O), carboxyl (—COOH), carboxy ester (—COOR), carbamyl (—CO—NH₂; —CO—NH—R; —CO—N—R₂), alkoxy (—OR), aryloxy (—OAr), hydroxyl (—OH), alkenyl (—CH═CHR), alkynyl (—C≡CR), naphthyl (C₁₀H₇—) and phenyl (C₆H₅—) radicals and radicals bearing at least one sulphur (S) and/or nitrogen (N) atom or at least one halogen.

Specific examples of such an activating group which may be mentioned in particular, besides those already mentioned, are acetyl, propionyl, benzoyl, toluyl, formyl, methoxycarbonyl, ethoxycarbonyl, methylcarbamyl, ethylcarbamyl, benzylcarbamyl, phenylcarbamyl, dimethylcarbamyl, diethylcarbamyl, dibenzylcarbamyl, diphenylcarbamyl, methoxy, ethoxy, phenoxy, benzyloxy, vinyl, isopropenyl, isobutenyl, ethynyl, xylyl, tolyl, methylthio, ethylthio, benzylthio, phenylthio, thiocarbonyl, thiuram, sulphinyls, sulphonyls, thiocyanato, amino, toluidino, xylidino, cyano, cyanato, isocyanato, isothiocyanato, hydroxyamino, acetamido, benzamido, nitroso, nitro, azo, hydrazo, hydrazino, azido and ureido radicals and radicals bearing at least one chlorine or bromine atom.

Even more preferably, the electron-withdrawing group is chosen from carbonyls, carboxyls, carboxy esters and radicals bearing sulphur and/or nitrogen with a carbonyl root.

A coupling agent bearing at least one ethylenic double bond activated with an adjacent radical bearing a (C═O) bond is most particularly used in the composition in accordance with the invention.

As regards the functionality Y, it is advantageously chosen from at least one hydroxyl radical, at least one alkoxy radical of formula R¹O in which R¹ represents a linear or branched alkyl radical containing from 1 to 15 carbon atoms, and a mixture of hydroxyl and alkoxy radicals. Preferably, the functionality Y is chosen from at least one hydroxyl radical, at least one linear or branched alkoxy radical containing from 1 to 6 carbon atoms, and a mixture of hydroxyl and C₁-C₆ alkoxy radicals. More preferably, the functionality Y is chosen from at least one hydroxyl radical, at least one linear or branched alkoxy radical containing from 1 to 3 carbon atoms (that is to say methoxy, ethoxy, propoxy and/or isopropoxy) and a mixture of hydroxyl and C₁-C₃ alkoxy radicals.

Coupling agents included in the scope of the present invention are coupling agents or compounds A which comprise multifunctional POSs containing identical or different units of formula:

$$\begin{matrix}{( {R}^{2} )}_{a} {Y}_{b} {X}_{c} SiO & \\ & \frac{4 - ( a + b + c )}{2}\end{matrix} \qquad ( I )$$

in which:

(1) the symbols R², which may be identical or different, each represent a monovalent hydrocarbon-based group chosen from a linear or branched alkyl radical containing from 1 to 6 carbon atoms, a cycloalkyl radical containing from 5 to 8 carbon atoms and a phenyl radical; preferably, the symbols R² are chosen from methyl, ethyl, n-propyl, isopropyl, n-butyl, n-pentyl, cyclohexyl and phenyl radicals; more preferably, the symbols R² are methyl radicals;

(2) the symbols Y, which may be identical or different, each represent a hydroxyl or alkoxy R¹O function, the definition of which is that given above with regard to the functionality Y;

(3) the symbols X, which may be identical or different, each represent a function bearing an activated ethylenic double bond chosen:

(3.1) from functions bearing an ethylenic double bond activated with at least one activating group having the general or specific definitions mentioned above;

(3.2) or, advantageously, from radicals having the formulae (X/a), (X/b) and (X/c) below, and mixtures thereof

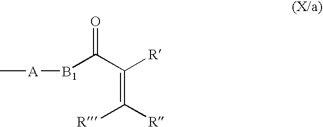

(the existence of cis and/or trans double bond structures being possible)

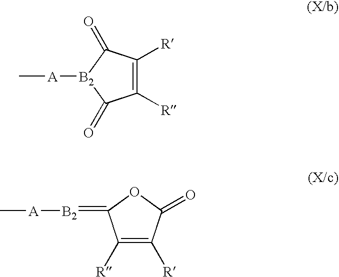

in which formulae:

B₁ is O, NH, N-alkyl, N-phenyl, S, CH₂, CH-alkyl or CH-phenyl;

B₂ is N, CH, C-alkyl or C-phenyl;

the radicals R′, R″ and R, which may be identical or different, each represent a hydrogen atom, a halogen atom, a cyano radical, a linear or branched alkyl radical containing from 1 to 6 carbon atoms or a phenyl radical, the radicals R″ and/or R also possibly representing a monovalent COOH group or a derived group such as an ester or amide;

the divalent radical A is intended to provide the bonding with the polysiloxane chain and consists of a saturated or unsaturated divalent hydrocarbon-based radical which may comprise one or more hetero atoms such as oxygen and nitrogen, containing from 1 to 18 carbon atoms;

(3.3) or, very advantageously, from radicals having the formulae (II/1) to (II/5) below, and mixtures thereof:

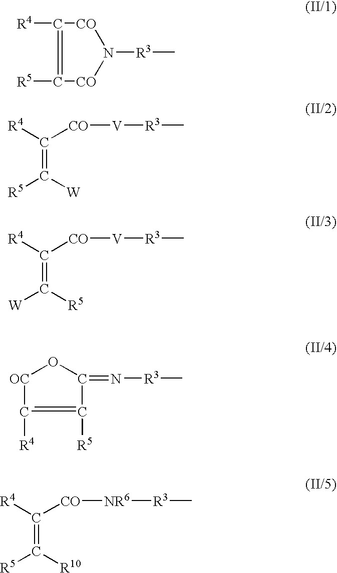

in which formulae:

the symbol V represents a divalent radical —O— or —NH⁶—; preferably, the symbol V is a radical —O— or —NR⁶— in which R⁶ has the preferred definition given below; more preferably, the symbol V is a radical —O— or —NR⁶— in which R⁶ has the more preferred definition given below;

the symbol W represents a monovalent group COOR⁷ or a monovalent group CONR⁸R⁹; preferably, the symbol W is a group COOR or a group CONR⁸R⁹ in which the radicals R⁷, R⁸ and R⁹ have the preferred definitions given below; more preferably, the symbol W is a group COOR⁷ or a group CONR⁸R⁹ in which the radicals R⁷, R⁸ and R⁹ have the more preferred definitions given below;

R³ is a linear or branched divalent alkylene radical containing from 1 to 15 carbon atoms, the free valency of which is borne by a carbon atom and is linked to a silicon atom, the said radical R³ possibly being interrupted in the alkylene chain with at least one hetero atom (such as oxygen and nitrogen) or at least one divalent group comprising at least one hetero atom (such as oxygen and nitrogen), and in particular with at least one divalent residue of general formula ^{V1}residue^{V2} chosen from: —O—, —CO—, —CO—O—, —COO-cyclohexylene (optionally substituted with an OH radical)-, —O-alkylene (linear or branched C₂-C₆, optionally substituted with an OH or COOH radical)-, —O—CO-alkylene (linear or branched C₂-C₆, optionally substituted with an OH or COOH radical)-, —CO—NH—, O—CO—NH— and —NH-alkylene (linear or branched C₂-C₆)—CO—NH—; R³ also represents a divalent aromatic radical of general formula ^{V1}residue^{V2} chosen from: -(ortho, meta or para)phenylene(linear or branched C₂-C₆)alkylene-, -(ortho, meta or para)phenylene-O-(linear or branched C₂-C₆)alkylene-, -(linear or branched C₂-C₆)alkylene-(ortho, meta or para)phenylene(linear or branched C₁-C₆)alkylene-, and -(linear or branched C₂-C₆)alkylene(ortho, meta or para)phenylene-O-(linear or branched C₁-C₆)alkylene-; preferably, the symbol R³ represents an alkylene radical which corresponds to the following formulae: —(CH₂)₂—, —(CH₂)₃—, —(CH₂)₄—, —CH₂—CH(CH₃)—, —(CH₂)₂—CH(CH₃)—CH₂—, —(CH₂)₃—O—(CH₂)₃—, —(CH₂)₃—O—CH₂—CH(CH₃)—CH₂—, —(CH₂)₃—O—CH₂CH(OH)—CH₂—; more preferably, R³ is a —(CH₂)₂— or —(CH₂)₃-radical; with the specific detail that, in the preceding definitions of R³, when the divalent residues and radicals mentioned are not symmetrical, they may be positioned with the valency v1 to the left and the valency v2 to the right, or vice versa with the valency v2 to the left and the valency v1 to the right;

the symbols R⁴ and R⁵, which may be identical or different, each represent a hydrogen atom, a halogen atom, a cyano radical, a linear or branched alkyl radical containing from 1 to 6 carbon atoms or a phenyl radical, R⁵ also possibly representing a monovalent group COOR⁷; preferably, the symbols R⁴ and R⁵ are chosen from a hydrogen atom, a chlorine atom and methyl, ethyl, n-propyl and n-butyl radicals, R⁵ also possibly representing a group COOR⁷ in which the radical R⁷ has the preferred definition given below; more preferably, these symbols are chosen from a hydrogen atom and a methyl radical, R⁵ also possibly representing a group COOR⁷ in which the radical R⁷ has the more preferred definition given below;

the symbols R⁶, R⁷, R⁸, R⁹ and R¹⁰, which may be identical or different, each represent a hydrogen atom, a linear or branched alkyl radical containing from 1 to 6 carbon atoms or a phenyl radical, the symbols R⁸ and R⁹ also possibly forming, together with the nitrogen atom to which they are attached, a single saturated ring containing from 3 to 8 carbon atoms in the ring; preferably, the symbols R⁶, R⁷, R⁸, R⁹ and R¹⁰ are chosen from a hydrogen atom and methyl, ethyl, n-propyl and n-butyl radicals, the symbols R⁸ and R⁹ also possibly forming, together with the nitrogen atom, a pyrrolidinyl or piperidyl ring; more preferably, these symbols are chosen from a hydrogen atom and a methyl radical, the symbols R⁸ and R⁹ also possibly forming, together with the nitrogen atom, a piperidyl ring;

(4) the symbols a, b and c each represent integers or fractions chosen from:

a: 0, 1, 2 or 3;

b: 0, 1, 2 or 3;

c: 0 or 1;

the sum a+b+c being other than zero and ≦3;

(5) the content of units R¹¹SiO_{3/2} (units “T”) in which R¹¹ is chosen from the radicals corresponding to the definitions of R², Y and X, this content being expressed as the number, per molecule, of these units per 100 silicon atoms, is less than or equal to 30% and preferably less than or equal to 20%;

(6) the content of functions Y, expressed as the number, per molecule, of functions Y per 100 silicon atoms, is at least 0.8% and is preferably in the range from 1% to 100%;

(7) the content of functions X, expressed as the number, per molecule, of functions X per 100 silicon atoms, is at least 0.4% and is preferably in the range from 0.8% to 100%.

Given the values which symbols a, b and c may take and the details given in point (5), it should be understood that each multifunctional POS of formula (I) may have either a linear structure or a cyclic structure, or a mixture of these structures, these structures also possibly having a certain molar amount of branching (units “T”).

Given the meanings given above in point (3) regarding the symbols X, it should be understood that a multifunctional POS in accordance with the formula (I) may in particular bear:

maleimide (II/1), isomaleimide (II/4) and acrylamide (II/5) fucntion(s);

maleamic acid and/or fumaramic acid function(s), when, in formulae (II/2) and/or (II/3), the symbol V=—NR⁶— and the symbol W=COOR⁷ in which R⁷=H;

maleic ester and/or fumaric ester function(s), when, in formulae (II/2) and/or (II/3), the symbol V=—O— and the symbol W=COOR⁷ in which R⁷ is other than H;

maleamic ester and/or fumaramic ester function(s), when, in formulae (II/2) and/or (II/3), either the symbol V=NR⁶— and the symbol W=COOR⁷ in which R⁷ is other than H, or the symbol V=—O— and the symbol W=CONR⁸R⁹;

maleamide and/or fumaramide function(s), when, in formulae (II/2) and/or (II/3), the symbol V=—NR⁶— and the symbol W=CONR⁸R⁹.

It has been stated above that the coupling agent is a compound “which comprises a multifunctional POS”; this expression should be interpreted as meaning that the coupling agent or compound A forming part of the present invention may be in the form of a multifunctional POS in pure form or in the form of a mixture of such a POS with a variable weight amount (generally much less than 50% in the mixture) of another (or of other) compound(s) which may consist of:

(i) one and/or other of the starting reagents from which the multifunctional POSs are prepared, when the degree of conversion of the said reagents is not complete; and/or

(ii) the product(s) derived from a complete or incomplete modification of the silicone skeleton of the starting reagent(s); and/or

(iii) the product(s) derived from a modification of the silicone skeleton of the desired multifunctional POS, prepared by a condensation reaction, a hydrolysis and condensation reaction and/or a redistribution reaction.

To be more specific, the coupling agents or compounds A which are included in the scope of the invention are those which comprise multifunctional POSs chosen from the family of POSs in accordance with formula (I), which are essentially linear and have the average formula below:

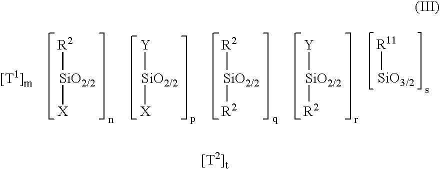

in which:

(1′) the symbols T¹ are chosen from the units HO_{1/2} and R₁O_{1/2}, in which the radical R¹ is as defined above;

(2′) the symbols T², which may be identical to or different from the symbols T¹, are chosen from the units HO_{1/2} and R¹O_{1/2} and the unit (R²)₃SiO_{1/2}, in which the radicals R¹ and R² are as defined above in points (2) and (1) regarding formula (I);

(3′) the symbols R², X and Y are as defined above in points (1), (3) and (2) regarding formula (I);

(4′) the symbols R″ are chosen from the radicals corresponding to the definitions of R², X and Y;

(5′) the symbols m, n, p, q, r, s and t each represent integers or fractions which satisfy the following cumulative conditions:

m and t are each numbers that are always other than zero, the sum of which is equal to 2+s,

n is in the range from 0 to 100,

p is in the range from 0 to 100,

q is in the range from 0 to 100,

r is in the range from 0 to 100,

s is in the range from 0 to 75,

when n=0, p is always a number other than 0 and when p=0, n is always a number other than zero,

the sum n+p+q+r+s+t giving the total number of silicon atoms is in the range from 2 to 250,

the ratio 100 s/(n+p+q+r+s+t) giving the content of units “T” is ≦30 and preferably ≦20,

the ratio 100(m+p+r+s [when R¹¹=Y]+t)/(n+p+q+r+s+t) giving the content of functions Y (borne by the units represented by the symbols T¹, T² and Y) is ≧1 and preferably ranges from 4 to 100,

the ratio 100(n+p+s [when R¹¹=X])/(n+p+q+r+s+t) giving the content of functions X is ≧1 and preferably ranges from 2 to 100.

As coupling agents or compounds A which are preferably used, mention may be made of those comprising the essentially linear oligomers and polymers POS/1 which correspond to formula (III) in which (in this case, these will be referred to for short as polymers POS/1 of imide type):

(1″) the symbols T¹ are defined as given above in point (1′);

(2″) the symbols T are defined as given above in point (2′);

(3″)

the functions X, which may be identical or different, are chosen from the radicals of formulae (II/1), (II/2) and (II/3), and mixtures thereof, with the following conditions according to which:

in the formulae (II/2) and (II/3), the symbol V=—NR⁶— in which R⁶=H, R⁵ is other than a group COOR⁷ and the symbol W=COOR⁷ in which R⁷=H,

at least one of the functions X corresponds to the formula (II/1),

when, where appropriate, there is a mixture of function(s) X of formula (II/1) with functions X of formulae (II/2) and/or (II/3), the mole fraction of functions X of formulae (II/2) and/or (II/3) in all of the functions X is on average less than or equal to 12 mol % and preferably less than or equal to 5 mol %,

the symbols R³, R⁴ and R⁵ (other than a group COOR⁷) are as defined above in point (3.3) regarding formula (I);

the symbols R² and Y are as defined above in points (1) and (2) regarding formula (I);

(4″) the symbols R¹¹ are chosen from the radicals R², the functions X in accordance with point (3″) and the functions Y;

(5″) the symbols m, n, p, q, r, s and t satisfy the following cumulative conditions:

m+t=2+s,

n is in the range from 0 to 50,

p is in the range from 0 to 20,

when n=0, p is at least equal to 1 and when p=0, n is at least equal to 1,

q is in the range from 0 to 48,

r is in the range from 0 to 10,

s is in the range from 0 to 1,

the sum n+p+q+r+s+t giving the total number of silicon atoms is in the range from 2 to 50,

the ratio 100s/(n+p+q+r+s+t) giving the content of units “T” is ≦10,

the ratio 100(m+p+r+s [when R¹¹=Y]+t)/(n+p+q+r+s+t) giving the content of functions Y (provided by the units represented by symbols T¹, T² and Y) ranges from 4 to 100 and better still from 10 to 100,

the ratio 100(n+p+s [when R¹¹=X])/(n+p+q+r+s+t) giving the content of functions X ranges from 10 to 100 and better still from 20 to 100.

As other coupling agents or compounds A which are also preferably used, mention may be made of those comprising the essentially linear oligomers and polymers POS/2 which correspond to formula (III) in which:

(1) the symbols T¹ are defined as given above in point (1′);

(2) the symbols T², which may be identical to or different from the symbols T¹, are chosen from the unit HO_{1/2} and the unit R¹O_{1/2} as defined above in point (1′);

(3) the functions X, which may be identical or different, are chosen from:

either the radicals of formulae (II/2) and (II/3) and mixtures thereof, in which:

firstly, the symbol V=—NR⁶—, R⁵ is other than a group COOR⁷ and the symbol W=COOR⁷ in which R⁷=H, and

secondly, the symbols R³, R⁴, R⁵ (other than a group COOR⁷) and R⁶ are chosen as given above in point (3.3) regarding formula (I),

(in this case, the polymer will then be referred to for short as a polymer POS/2 of acid type),

or the radicals of formulae (II/2) and (II/3) and mixtures thereof, in which:

firstly, the symbol V=—NR⁶—, R⁵ is other than a group COOR⁷ and the symbol W=COOR⁷ in which R⁷, which is other than H, is a radical as defined above in point (3.3) regarding formula (I), and

secondly, the symbols R³, R⁴, R⁵ (other than a group COOR⁷) and R⁶ are chosen as given above in point (3.3) regarding formula (I),

(in this case, the polymer will then be referred to for short as a polymer POS/2 of ester type),

the symbols R² and Y are as defined above in points (1) and (2) regarding formula (I);

(4) the symbols R¹¹ are chosen from the radicals R², the functions X in accordance with point (3) and the functions Y;

(5) the symbols m, n, p, q, r, s and t satisfy the following cumulative conditions:

m+t=2+s,

n is in the range from 0 to 50,

p is in the range from 0 to 20,

when n=0, p is at least equal to 1 and when p=0, n is at least equal to 1,

q is in the range from 0 to 48,

r is in the range from 0 to 10,

s is in the range from 0 to 1,

the sum n+p+q+r+s giving the total number of silicon atoms is in the range from more than 2 to 50,

the ratio 100s/(n+p+q+r+s) giving the content of units “T” is ≦10,

the ratio 100(m+p+r+s [when R¹¹=Y]+t)/(n+p+q+r+s) giving the content of functions Y (provided by the units represented by the symbols T¹, T² and Y) ranges from 4 to 100 and better still from 10 to 100,

the ratio 100(n+p+s [when R¹¹=X])/(n+p+q+r+s) giving the content of functions X ranges from 10 to 100 and better still from 20 to 100.

Coupling agents or compounds A which are also included in the scope of the invention are those which comprise multifunctional POSs chosen from the family of POSs in accordance with the formula (I), which are cyclic and have the average formula below:

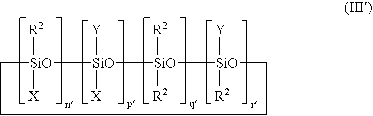

in which:

(3) the symbols R², X and Y are as defined above in points (1), (3) and (2) regarding formula (I);

(5) the symbols n′, p′, q′ and r′ each represent integers or fractions which satisfy the following cumulative conditions:

n′ is in the range from 0 to 9,

p′ is in the range from 0 to 9,

when n′=0, p′ is at least equal to 1,

when p′=0, n′ is at least equal to 1 and r′ is also at least equal to 1,

q′ is in the range from 0 to 9,

r′ is in the range from 0 to 2,

the sum n′+p′+q′+r′ is in the range from 3 to 10,

the ratio 100(p′+r′)/(n′+p′+q′+r′) giving the content of function Y ranges from 4 to 100,

the ratio 100(n′+p′)/(n′+p′+q′+r′) giving the content of functions X ranges from 10 to 100.

It should be noted that these cyclic multifunctional POSs may be obtained as a mixture with the essentially linear multifunctional POSs of formula (III).

The coupling agents or compounds A comprising the multifunctional POSs in accordance with formulae (I), (III) and (III′) given above are prepared by various processes. These processes involve in particular:

a hydrolysis and condensation reaction of a dihalosilane or of a dialkoxysilane bearing a function X, optionally in the presence of a dihalosilane or of a dialkoxysilane,

a condensation reaction between an organosilane bearing a function X and at least two functions Y, and an α,ω-dihydroxy linear POS,

a redistribution and equilibration reaction between an organosilane bearing a function X and at least two functions Y and/or halo, and an organocyclosiloxane optionally bearing one or more functions Y in the chain,

a coupling reaction between an organosilane bearing a function X and at least two functions Y, and a polysilazane,

a coupling reaction between a linear or cyclic precursor POS bearing at least one function Y and functionalized with at least one unit attached to a silicon atom, in particular of -(linear or branched C₂-C₆)alkylene-OH, -(linear or branched C₂-C₆)alkylene-NR⁶H or -(linear or branched C₂-C₆)alkylene-COOH type, and a reactive compound capable of reacting with the above-mentioned unit(s) to generate the desired function X,

an esterification reaction of a linear or cyclic POS bearing at least one function Y and at least one function X of formula (II/2) or (II/3) in which the symbol W represents a COOH group.

More specifically, the coupling agents or compounds A comprising the multifunctional POSs in accordance with formulae (I), (III) and (III′) are prepared by a process which consists, for example:

(a) in hydrolysing, in aqueous medium, an organosilane of formula:

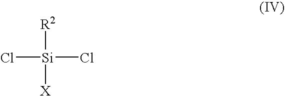

in which the symbols R² and X have the definitions already given above, optionally working in the presence of an organosilane of formula:

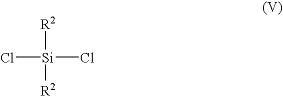

Such a process is suitable for preparing compounds A comprising multifunctional POSs of formula (III) in which the symbols T¹ and T² each represent the unit HO_{1/2} and in which, firstly, p=r=s=0 and, secondly, q is either equal to zero [when the silane (IV) is hydrolysed in the absence of silane (V)], or a number other than zero [when the silane (IV) is hydrolysed in the presence of the silane (V)]. As regards the practical method for carrying out this process, reference will be made for further details to the content of FR-A-2 514 013;

(b) in condensing, optionally in the presence of a catalyst based, for example, on a tin carboxylate, an organosilane of formula:

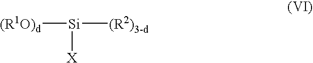

in which the symbols R¹, R² and X are as defined above and d is a number chosen from 2 and 3, with a POS of formula:

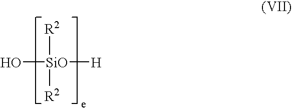

in which the symbol R² is as defined above and e is an integer or fraction ranging from 2 to 50. Such a process is suitable for preparing compounds A comprising multifunctional POSs of formula (III) in which the symbols T¹ and T² lie in a mixture of units HO_{1/2} with units R¹O_{1/2} and in which the symbols p, r and s may be other than zero when d=3, whereas, irrespective of the value of d, q is other than zero. As regards the practical method for carrying out this process, reference may be made for further details to the content of U.S. Pat. No. 3,755,351;

(c) in carrying out a redistribution and equilibration reaction, in the presence of a suitable catalyst and water, between, on the one hand, an organosilane of formula:

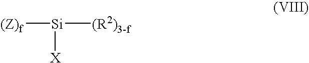

in which the symbols R² and X are as defined above, the symbol Z is chosen from hydroxyl, R¹O and halo (such as, for example, chlorine) radicals and f is a number chosen from 2 and 3, and, on the other hand, an organocyclosiloxane of formula:

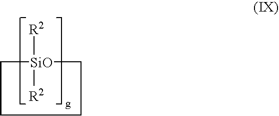

in which the symbols R² are as defined above and g is a number ranging from 3 to 8, and optionally a dihydroxy POS of formula (VII). Such a process is suitable for preparing further compounds A comprising POSs of formula (III) in which the symbols T¹ and T² represent units HO_{1/2} and the symbol q is other than zero.

The coupling agents or compounds A which are preferably used in the context of the invention are those comprising polymers POS/1 of imide type. One advantageous procedure for preparing the coupling agents or compounds A comprising polymers POS/1 of imide type corresponds to a process (d) for preparing compounds comprising polymers POS/1 of imide type in the formula (III) of which the symbol q is equal to zero and consists in carrying out steps (d1) and (d2) below:

(d1) a reaction is carried out between:

an organosilane of formula (VI) in which the symbol X represents the function of formula (II/2) in which V=—NR⁶ with R⁶=H, R⁵ is other than a group COOR⁷ and W=COOR⁷ with R⁷==H, that is to say an organosilane of formula:

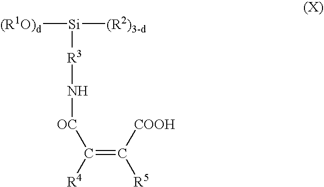

and a disilazane of formula:

(R²)₃Si—NH—Si(R²)₃ (XI)

in which formula the symbols R¹, R², R³, R⁴ and R⁵ are radicals corresponding to the definitions given in points (1), (2) and (3.3) regarding formula (I) and d is a number chosen from 2 and 3,

this reaction being carried out in the presence of a catalyst, which may or may not be supported on a mineral material (such as, for example, a siliceous material), based on at least one Lewis acid, working at atmospheric pressure and at a temperature in the range from room temperature (23° C.) to 150° C. and preferably ranging from 60° C. to 120° C.;

(d2) stabilization of the reaction medium obtained is carried out by treating this medium with at least one halosilane of formula (R²)₃ Si-halo in which the halo residue is preferably chosen from a chlorine atom and a bromine atom, working in the presence of at least one non-nucleophilic organic base which is unreactive towards the imide function formed in situ during step (d1).

The disilazane is used in an amount at least equal to 0.5 mol per 1 mol of starting organosilane and preferably ranging from 1 to 5 mol per 1 mol of organosilane.

The preferred Lewis acid is ZnCl₂ and/or ZnBr₂ and/or ZnI₂. It is used in an amount at least equal to 0.5 mol per 1 mol of organosilane and preferably ranging from 1 to 2 mol per 1 mol of organosilane.

The reaction is carried out in heterogeneous medium, preferably in the presence of a solvent or a mixture of solvents that are common with organosilicon reagents. The preferred solvents are of the polar aprotic type such as, for example, chlorobenzene, toluene, xylene, hexane, octane and decane. The solvents more preferably selected are toluene and xylene.

This process (d) may be carried out according to any procedure which is known per se. One procedure which is suitable is as follows: in a first stage, the reactor is fed with the Lewis acid and a solution of the organosilane in all or some of the solvent(s) is then gradually added; in a second stage, the reaction mixture is brought to the chosen temperature and the disilazane is then added, which may optionally be used in the form of a solution in some of the solvent(s); next, in a third stage, the reaction mixture obtained is treated with at least one halosilane in the presence of one or more organic base(s) in order to stabilize it; and finally, in a fourth stage, the stabilized reaction medium is filtered to remove the Lewis acid and the salt formed in situ during the stabilization, and it is then devolatilized under reduced pressure to remove the solvent(s).

As regards the stabilization step (d2), the halosilane(s) is (are) used in an amount at least equal to 0.5 mol per 1 mol of starting organosilane and preferably ranging from 0.5 to 1.5 mol per 1 mol of organosilane. As regards the organic bases, the ones that are preferred are, in particular, tertiary aliphatic amines (such as, for example, N-methylmorpholine, triethylamine and triisopropylamine) and hindered cyclic amines (such as, for example, 2,2,6,6-tetraalkylpiperidines). The organic base(s) is (are) used in an amount at least equal to 0.5 mol per 1 mol of starting organosilane and preferably ranging from 0.5 to 1.5 mol per 1 mol of organosilane.

A second advantageous procedure, which may be used for preparing coupling agents or compounds A comprising polymers POS/1 of imide type, corresponds to a process (e) for preparing compounds comprising polymers POS/1 of imide type in the formula (III) of which the symbol q is other than zero, and consists in carrying out the single step (d1) defined as indicated above, but in which the disilazane of formula (XI) has been replaced with a cyclic polysilazane of formula:

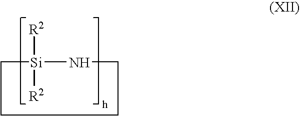

in which the symbols R² are as defined above and h is a number ranging from 3 to 8.

This process (e) may be carried out using the suitable procedure given above with regard to the implementation of process (d), and based on carrying out only the first stage, second stage and fourth stage mentioned above. It should be noted, however, that polysilazane is used in an amount at least equal to 0.5/h mol per 1 mol of starting organosilane and preferably ranging from 1/h to 5/h mol per 1 mol of organosilane (h being the number of silazane units in the polysilazane of formula (XII)).

The implementation of processes (d) and (e), like that of processes (f), (g) and (h) which are given later in the present specification, leads to the production of a coupling agent or compound A which may be in the form of a multifunctional POS in pure form (or compound A_{POS}) or in the form of a mixture of a multifunctional POS (or compound A_{POS}) with a variable weight amount (generally very much less than 50% in the mixture) of another (or of other) compound(s) which may consist, for example, of:

(i) a small amount of the unreacted starting organosilane of formula (X); and/or

(ii) a small amount of the organosilane of formula:

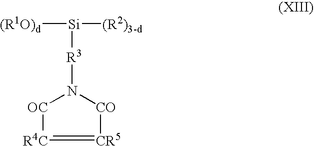

formed by direct cyclization of the corresponding amount of the starting organosilane of formula (X); and/or

(iii) a small amount of the cyclic monofunctional POS of formula:

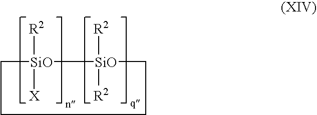

in which:

the symbols R² are as defined above in point (1) regarding formula (I),

the symbols X are as defined above in points (3″) or (3) regarding formula (III),

the symbols n″ and q″ are integers or fractions which satisfy the following cumulative conditions:

n″ is in the range from 1 to 9,

q″ is in the range from 1 to 9,

the sum n″+q″ is in the range from 3 to 10,

the said cyclic monofunctional POS being derived from a modification of the silicone skeleton of the desired multifunctional POS.

The coupling agents or compounds A which are more preferably used in the context of the invention are those comprising the polymers POS/2 of acid type or of ester type.

One advantageous procedure, which may be used to prepare the coupling agents or compounds A comprising the polymers POS/2, corresponds, when it is desired to prepare compounds comprising polymers POS/2 of acid type, to a process (f) which consists in carrying out a coupling reaction between:

on the one hand, an essentially linear amino POS, having the same formula (ill) as that given above with regard to the definition of the POS/2, but in which the symbol X is now an amino function of formula —R³—NR⁶H in which the symbols R³ and R⁶ are as defined above in point (3.3) regarding formula (I); the said amino POS is represented for short in the text hereinbelow by the simplified formula:

Si—R³—NR⁶H (XV)

and, on the other hand, maleic anhydride or a derivative thereof of formula:

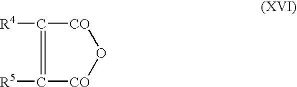

in which the symbols R⁴ and R⁵ are as defined above in point (3.3) regarding formula (I).

The amino POS of formula (XV) may be prepared, in a manner which is known per se, by carrying out, for example, a redistribution and equilibration reaction between, on the one hand, a POS which results from a hydrolysis of an alkoxysilane bearing an amino function of formula:

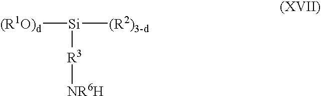

in which the symbols R¹, R², d, R³ and R⁶ are as defined above with regard to formulae (VI) to (XV), and, on the other hand, an α,ω-dihydroxy POS of formula (VII).

As regards the practical method for carrying out the coupling reaction between the amino POS (XV) and the maleic anhydride (XVI), this is a reaction which is known per se, which is usually carried out at a temperature ranging from room temperature (23° C.) to 80° C., working in the presence of a solvent or a mixture of solvents. Reference may be made for further details to the content of document U.S. Pat. No. 3,701,795.

The coupling agents or compounds A comprising the polymers POS/2 of ester type, which constitute another category of coupling agents which are also preferably targeted in the context of the present invention, may be prepared by applying the advantageous procedures defined below.

According to a first process (g), the coupling agents or compounds A comprising the polymers POS/2 of ester type may be prepared by esterification of an intermediate maleamic acid POS by carrying out the following steps: (g1) coupling reaction, as explained above with regard to process (f), between the amino POS (XV) and the maleic anhydride (XVI), and then (g2) esterification reaction of the medium comprising the POS/2 of acid type formed, to give the compound comprising the desired POS/2 of ester type, by applying the following synthetic scheme:

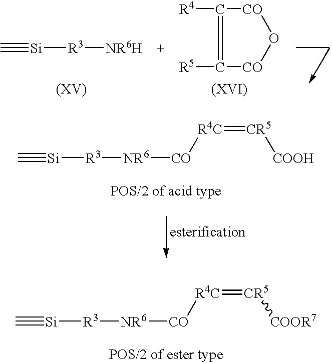

As regards the practical method for carrying out step (g2), reference may be made for further details to the contents of the following documents which describe, optionally starting with other reagents, procedures which may be applied for carrying out this step:

(i) reaction of an ammonium salt of the carboxylic acid with an agent such as the organic sulphate of formula (R⁷)₂SO₄ or the organic iodide of formula R⁷I: cf. in particular Can. J. Chem., 65, 1987, pages 2179-2181 and Tetrahedron Letters No. 9, pages 689-692, 1973;

(ii) reaction of the acid chloride of the carboxylic acid with the alcohol of formula R⁷OH in the presence of an amine base: cf. in particular Heterocycles, 39, 2, 1994, pages 767-778 and J. Org. Chem., 26, 1961, pages 697-700;

(iii) transesterification reaction in the presence of an ester such as the formate of formula H—COOR⁷: cf. in particular Justus Liebigs Ann. Chem., 640, 1961, pages 142-144 and J. Chem. Soc., 1950, pages 3375-3377;

(iv) methylation reaction with diazomethane which allows the methyl ester to be prepared easily: cf. in particular Justus Liebigs Ann. Chem., 488, 1931, pages 211-227;

(v) direct esterification reaction with the alcohol R⁷—OH: cf. in particular Org. Syn. Coll., vol. 1, pages 237 and 451, 1941 and J. Org. Chem., 52, 1987, page 4689.

According to a second process (h) which corresponds to a preferred synthetic route, the coupling agents or compounds A comprising the polymers POS/2 of ester type may be prepared by forming an amide function and adding the amine POS (XV) to an ester derivative (XIX) obtained from a monoester of the maleic acid (XVIII), by carrying out the following steps: (h1) alcoholysis of the maleic anhydride (XVI) with the alcohol R⁷—OH, (h2) activation of the carboxylic acid function of the monoester of the maleic acid (XVIII) obtained, using the various activation methods described in the field of peptide synthesis, to give the activated ester derivative (XIX), and then (h3) addition of the amino POS (XV) to the said activated ester derivative (XIX) to give the compound comprising the desired POS/2 of ester type, by applying the following synthetic scheme:

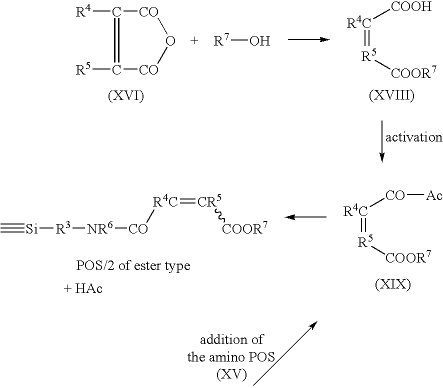

in which the symbol Ac of the derivative (XIX) represents an activating function.

As regards the practical method for carrying out steps (h1) to (h3), reference will be made for further details to the contents of the following documents which describe, optionally starting from other reagents, procedures which may be applied to the implementation of the various steps of the process under consideration:

for step (h1): cf. in particular J. Med. Chem., 1983, 26, pages 174-181;

for steps (h2) and (h3): cf. John Jones, Amino Acid and Peptide-Synthesis, pages 25-41, Oxford University Press, 1994.

In order to allow the addition of the amine function to the carboxylic acid function of the maleic acid monoester (XVIII), the said carboxylic acid function should be activated beforehand, and this activation may be carried out in particular by using the following methods:

(j) activation by reaction with an alkyl chloroformate according to the scheme:

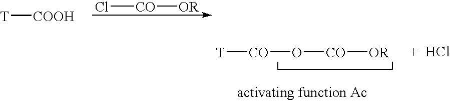

in which T represents the residue —R⁴C═CR⁵—COOR⁷ and R represents a linear alkyl radical containing, for example, 1 to 3 carbon atoms;

(2j) activation by reaction with dicyclohexylcarbodiimide (DCCI) preferably in the presence of N-hydroxysuccinimide (HO—SN), according to the scheme:

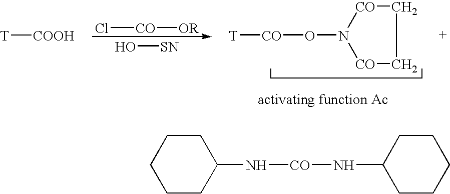

(3j) activation by reaction with a chlorinated compound such as, for example, thionyl chloride or phosphorus pentachloride, according to the scheme:

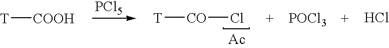

The activation methods (j) and (2j) are especially preferred.

To return to the general processes (b) and (c) for preparing compounds based on multifunctional POSs, they may be advantageously carried out starting, for example, with an organosilane of formula:

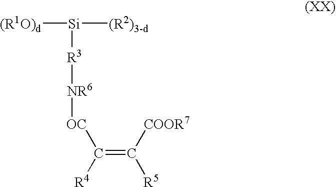

in which the symbols R¹, R², d, R³, R⁶, R⁴, R⁵ and R⁷ (other than H) are as defined above with regard to formula (VI) and point (3.3) regarding formula (I).

Such organosilanes are products which may be prepared by applying either of the processes (g1) and (g2) described above, in the implementation of which the amino POS (XV) will be replaced with the amino alkoxysilane of formula (XVII).

A person skilled in the art will understand that the POSs described above could be grafted beforehand onto the white reinforcing fillers, in particular onto silica, via their function(s) Y, the white reinforcing fillers thus precoupled then possibly being linked to the isoprene elastomer via their free function(s) X containing an activated ethylenic double bond.

Second Subject of the Invention

A second subject of the present invention relates to compositions comprising:

(B) at least one isoprene elastomer (referred to hereinbelow as compound B),

(C) a white reinforcing filler (referred to hereinbelow as compound C), and

(A) a suitable amount of coupling agent consisting of compound A comprising the multifunctional POS which has been defined above, firstly bearing at least one hydroxyl radical and/or at least one hydrolysable radical, and secondly bearing at least one activated ethylenic double bond (or compound A_{POS}).

More specifically, these compositions comprise (the parts are given on a weight basis):

per 100 parts of isoprene elastomer(s) or compound B,

from 10 to 150 parts of white filler or compound C, preferably from 30 to 100 parts and more preferably from 30 to 80 parts,

an amount of coupling agent or compound A which provides in the composition from 0.5 to 15 parts of compound A_{POS}, preferably from 0.8 to 10 parts and more preferably from 1 to 8 parts.

Advantageously, the amount of coupling agent, chosen in the abovementioned general and preferred regions, is determined such that it represents from 1% to 20%, preferably from 2% to 15% and more preferably from 3% to 8% relative to the weight of the white reinforcing filler.

We will return in the text hereinbelow to the definitions, in turn, of the compound B consisting of at least one isoprene elastomer, and of the compound C consisting of a white reinforcing filler.

The term “isoprene elastomers” which are used for the compositions in accordance with the second subject of the invention means, more specifically:

(1) synthetic polyisoprenes obtained by homopolymerization of isoprene or 2-methyl-1,3-butadiene;

(2) synthetic polyisoprenes obtained by copolymerization of isoprene with one or more ethylenically unsaturated monomers chosen from:

(2.1) conjugated diene monomers, other than isoprene, containing from 4 to 22 carbon atoms, such as, for example: 1,3-butadiene, 2,3-dimethyl-1,3-butadiene, 2-chloro-1,3-butadiene (or chloroprene), 1-phenyl-1,3-butadiene, 1,3-pentadiene, 2,4-hexadiene;

(2.2) vinylaromatic monomers containing from 8 to 20 carbon atoms, such as, for example: styrene, ortho-, meta- or para-methylstyrene, the “vinyltoluene” commercial mixture, para-tert-butylstyrene, methoxystyrenes, chlorostyrenes, vinylmesitylene, divinylbenzene, vinylnaphthalene;

(2.3) vinylic nitrile monomers containing from 3 to 12 carbon atoms, such as, for example, acrylonitrile and methacrylonitrile;

(2.4) acrylic ester monomers derived from acrylic acid or methacrylic acid with alkanols containing from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate, isobutyl methacrylate;

(2.5) a mixture of several of the abovementioned monomers (2.1) to (2.4) together;

the polyisoprene copolymers containing between 99% and 20% by weight of isoprene units between 1% and 80% by weight of diene, vinylaromatic, vinylic nitrile and/or acrylic ester units and consisting, for example, of poly(isoprene-butadiene), poly(isoprene-styrene) and poly(isoprene-butadiene-styrene);

(3) natural rubber;

(4) copolymers obtained by copolymerization of isobutene and isoprene (butyl rubber), as well as the halogenated versions, in particular chlorinated or brominated versions, of these copolymers;

(5) a mixture of several of the abovementioned elastomers (1) to (4) together;

(6) a mixture containing a major amount (ranging from 51% to 99.5% and preferably from 70% to 99% by weight) of abovementioned elastomer (1) or (3) and a minor amount (ranging from 49% to 0.5% and preferably from 30% to 1% by weight) of one or more diene elastomers other than isoprene elastomers.

The expression “diene elastomer other than an isoprene elastomer” means, in a manner which is known per se: the homopolymers obtained by polymerization of one of the conjugated diene monomers defined above in point (2.1), such as, for example, polybutadiene and polychloroprene; the copolymers obtained by copolymerization of at least two of the abovementioned conjugated dienes (2.1) together or by copolymerization of one or more of the abovementioned conjugated dienes (2.1) with one or more abovementioned unsaturated monomers (2.2), (2.3) and/or (2.4), such as, for example, poly(butadiene-styrene) and poly(butadiene-acrylonitrile).

Preferably, use is made of one or more isoprene elastomers chosen from: (1) synthetic polyisoprene homopolymers; (2) synthetic polyisoprene copolymers consisting of poly(isoprene-butadiene), poly(isoprene-styrene) and poly(isoprene-butadiene-styrene); (3) natural rubber; (4) butyl rubber; (5) a mixture of the abovementioned elastomers (1) to (4) together; (6) a mixture containing a major amount of abovementioned elastomer (1) or (3) and a minor amount of diene elastomer other than an isoprene elastomer, consisting of polybutadiene, polychloroprene, poly(butadiene-styrene) and poly(butadiene-acrylonitrile).

More preferably, use is made of one or more isoprene elastomers chosen from: (1) synthetic polyisoprene homopolymers; (3) natural rubber; (5) a mixture of the abovementioned elastomers (1) and (3); (6) a mixture containing a major amount of abovementioned elastomer (1) or (3) and a minor amount of diene elastomer other than an isoprene elastomer, consisting of polybutadiene and poly(butadiene-styrene).

In the present specification, the expression “white reinforcing filler” is intended to define a “white” (that is to say inorganic or mineral) filler, occasionally referred to as a “clear” filler, capable of reinforcing by itself, without any means other than that of a coupling agent, an elastomer composition of rubber type, which may be natural or synthetic.

The white reinforcing filler may be in any physical state, that is to say that the said filler may be in the form of powder, micropearls, granules or beads.

Preferably, the white reinforcing filler or compound C consists of silica, alumina or a mixture of these two species.

More preferably, the white reinforcing filler consists of silica, taken alone or as a mixture with alumina.

Any precipitated or pyrogenic silica known to those skilled in the art, with a BET specific surface ≦450 m²/g, is suitable as a silica which may be used in the invention. Precipitation silicas are preferred, these possibly being conventional or highly dispersible.

The expression “highly dispersible silica” means any silica which has a very strong ability to de-aggregate and to disperse in a polymer matrix, which may be observed by electron or optical microscopy, on thin slices. Non-limiting examples of highly dispersible silicas which may be mentioned include those with a CTAB specific surface of less than or equal to 450 m²/g and particularly those disclosed in patent U.S. Pat. No. 5,403,570 and patent applications WO-A-95/09127 and WO-A-95/09128, the content of which is incorporated herein. Treated precipitated silicas such as, for example, the aluminium-“doped” silicas disclosed in patent application EP-A-0 735 088, the content of which is also incorporated herein, are also suitable.

More preferably, precipitation silicas that are particularly suitable are those with:

a CTAB specific surface ranging from 100 to 240 m²/g and preferably from 100 to 180 m²/g,

a BET specific surface ranging from 100 to 250 m²/g and preferably from 100 to 190 m²/g,

a DOP oil uptake of less than 300 ml/100 g and preferably ranging from 200 to 295 ml/100 g,

a BET specific surface/CTAB specific surface ratio ranging from 1.0 to 1.6.

Needless to say, the term “silica” also means blends of different silicas. The CTAB specific surface is determined according to NFT method 45007 of November 1987. The BET specific surface is determined according to the Brunauer-Emmet-Teller method described in “The Journal of the American Chemical Society, vol. 80, page 309 (1938)” corresponding to NFT standard 45007 of November 1987. The DOP oil uptake is determined according to NFT standard 30-022 (March 1953) using dioctyl phthalate.

The alumina advantageously used as reinforcing alumina is a highly dispersible alumina with:

a BET specific surface ranging from 30 to 400 m²/g and preferably from 80 to 250 m²/g,

an average particle size of not more than 500 nm and preferably not more than 200 nm, and

a high content of reactive Al—OH surface functions,

as disclosed in document EP-A-0 810 258.

Non-limiting examples of such reinforcing aluminas which will be mentioned in particular include the aluminas A125, CR125 and D65CR from the company Baïkowski.

When the compositions in accordance with the second subject of the invention contain as coupling agent a compound A comprising a multifunctional POS bearing function(s) X chosen from the radicals of formulae (II/2), (II/3), (II/4) and/or (II/5), such as, for example, a compound A comprising a polymer POS/2 of acid type or a polymer POS/2 of ester type, it may be advantageous, if need be depending on the particular conditions for carrying out the invention and the final intention for the rubber compositions, to add at least one coupling activator or compound D to the composition.

The compositions in accordance with the invention may thus also contain at least one coupling activator which is capable of activating, that is to say of increasing the coupling function of the coupling agent described above; this coupling activator, which is used in very low proportion (not more than 1 part per 100 parts by weight of elastomer(s)), is a free-radical initiator of the thermal initiation type.

In a known manner, a free-radical initiator is an organic compound capable, after an energetic activation, of generating free radicals in situ, in its surrounding medium. The free-radical initiator which may be introduced into the compositions of the invention is an initiator of the thermal initiation type, that is to say that the supply of energy to create the free radicals must be provided in thermal form. It is thought that the generation of these free radicals can promote, during the manufacture (thermomechanical blending) of the rubber compositions, a better interaction between the coupling agent and the isoprene elastomer.

The free-radical initiator preferably chosen is one whose decomposition temperature is less than 180° C. and more preferably less than 160° C., such temperature ranges making it possible to benefit fully from the coupling-activation effect, during the manufacture of the compositions in accordance with the invention.

The coupling activator, when one is used, is preferably chosen from the group consisting of peroxides, hydroperoxides, azido compounds, bis(azo) compounds, peracids, peresters and a mixture of two or more than two of these compounds.

More preferably, the coupling activator, when one is used, is chosen from the group consisting of peroxides, bis(azo) compounds and peresters, or a mixture of two or more than two of these compounds. Examples which will be mentioned in particular include benzoyl peroxide, acetyl peroxide, lauryl peroxide, cumyl peroxide, t-butyl peroxide, t-butyl peracetate, t-butyl hydroperoxide, cumene hydroperoxide, t-butylcumyl peroxide, 2,5-dimethyl-2,5-bis(t-butyl)-3-hexyne peroxide, 1,3-bis(t-butylisopropyl)benzene peroxide, 2,4-dichlorobenzoyl peroxide, t-butyl perbenzoate, 1,1-bis(t-butyl)-3,3,5-trimethylcyclohexane peroxide, 1,1′-azobis(isobutyronitrile) (abbreviated as “AIBN”), 1,1′-azobis(sec-pentyinitrile) and 1,1′-azobis(cyclohexanecarbonitrile).

According to one particularly preferred embodiment, the free-radical initiator, when one is used, is 1,1-bis(t-butyl)-3,3,5-trimethylcyclohexane peroxide.

Such a compound is sold, for example, by the company Flexsys under the name Trigonox 29-40 (40% by weight of peroxide on a calcium carbonate solid support).

According to another particularly preferred embodiment, the free-radical initiator, when one is used, is 1,1′-azobis(isobutyronitrile).

Such a compound is sold, for example, by the company Du Pont de Nemours under the name Vazo 64.

As mentioned above, the free-radical initiator, when one is used, is used in very low proportion in the compositions in accordance with the invention, that is to say in a content ranging from 0.05 to 1 part, preferably from 0.05 to 0.5 part and even more preferably from 0.1 to 0.3 part per 100 parts of elastomer(s).

Needless to say, the compositions in accordance with the invention also contain all or some of the other additional constituents and additives usually used in the field of elastomer compositions and rubber compositions.

Thus, all or some of the other constituents and additives below may be used:

as regards the vulcanization system, mention will be made, for example, of:

vulcanizing agents chosen from sulphur and sulphur-donating compounds such as, for example, thiuram derivatives;

vulcanization accelerators such as, for example, guanidine derivatives, thiazole derivatives or sulphenamide derivatives;

vulcanization activators such as, for example, zinc oxide, stearic acid and zinc stearate;

as regards other additive(s), mention will be made, for example, of:

a conventional reinforcing filler such as carbon black (in this case, the white reinforcing filler used constitutes more than 50% of the total weight of white reinforcing filler+carbon black);

a conventional white filler which provides little or no reinforcement, such as, for example, clays, bentonites, talc, chalk, kaolin, titanium dioxide or a mixture of these species;

antioxidants;

anti-ozonizers such as, for example, N-phenyl-N′-(1,3-dimethylbutyl)-p-phenylenediamine;

plasticizers and processing adjuvants.

As regards the processing adjuvants, this is intended to define, in particular, additives which are capable, for example, of limiting and/or unifying the heating of the compositions and/or of avoiding the occurrence of scorching. Such additives may be lubricants, agents for covering the white filler (agent comprising only the function Y capable of physically and/or chemically bonding to the white filler) or prevulcanization inhibitors, and they may make it possible to substantially improve, if need be, the ease of use of the compositions in raw form. Such processing adjuvants consist, for example, of: polyols; polyethers (for example polyethylene glycols); primary, secondary or tertiary amines (for example trialkanolamines); α,ω-dihydroxy polydimethylsiloxanes. Such a processing adjuvant, when one is used, is used in a proportion of from 0.05 to 10 parts by weight and preferably 0.08 to 8 parts per 100 parts by weight of elastomer(s).

Third Subject of the Invention

A third subject of the present invention relates to the process for preparing elastomer compositions comprising a white reinforcing filler and an effective amount of coupling agent. This process may be performed according to a conventional one-step or two-step procedure.

According to the one-step process, all the constituents required with the general exception of the vulcanizing agent(s) and, optionally, the vulcanization accelerator(s) and/or the vulcanization activator(s), are introduced into and blended in a common internal mixer such as, for example, a Banbury mixer or a Brabender mixer. The result of this first mixing step is then repeated on an external mixer, generally a roll mixer, and the vulcanizing agent(s) and, optionally, the vulcanization accelerator(s) and/or the vulcanization activator(s) are added thereto.

It may be advantageous for the preparation of certain articles to use a two-step process, both steps of which are carried out in an internal mixer. In the first step, all the constituents required with the exception of the vulcanizing agent(s) and, optionally, the vulcanization accelerator(s) and/or the vulcanization activator(s), are introduced and blended. The aim of the second step which follows is essentially to subject the mixture to an additional heat treatment. The result of this second step is then also repeated on an external mixer in order to add thereto the vulcanizing agent(s) and, optionally, the vulcanization accelerator(s) and/or the vulcanization activator(s).

The working phase in the internal mixer is generally performed at a temperature ranging from 80° C. to 200° C. and preferably from 80° C. to 180° C. This first working phase is followed by the second working phase in an external mixer working at a lower temperature, generally below 120° C. and preferably ranging from 25° C. to 70° C.

The final composition obtained is then calendered, for example in the form of a sheet, a plaque or a profile which may be used to manufacture elastomer articles.

The vulcanization (or curing) is carried out in a known manner at a temperature generally ranging from 130° C. to 200° C., for a sufficient time which can range, for example, between 5 and 90 minutes depending in particular on the curing temperature, the vulcanization system used and the vulcanization kinetics of the composition under consideration.

It goes without saying that the present invention, taken in its second subject, relates to the elastomer compositions described above both in raw form (i.e. before curing) and in cured form (i.e. after crosslinking or vulcanization).

Fourth Subject of the Invention

A fourth subject of the present invention relates to articles made of isoprene elastomer(s) with a body comprising the compositions described above in the context of the second subject of the invention. The present invention is particularly useful for preparing articles consisting, for example, of engine supports, shoe soles, cable-car rollers, seals for household electrical appliances and cable sheaths.

The examples which follow illustrate the present invention.

### EXAMPLE 1

This example illustrates the preparation of a coupling agent or compound A according to the invention, comprising a polymer POS/1 of imide type.

This compound A is prepared by carrying out process (d) outlined above in the present specification, with, as starting organosilane of formula (X), N-[γ-propyl(methyldiethoxy)silane]maleamic acid.

1. Preparation of the Starting Maleamic Acid Silane:

The process is performed in a 2-litre glass reactor equipped with a stirring system and an addition funnel. The γ-aminopropylsilane of formula (C₂H₅O)₂CH₃Si(CH₂)₃NH₂ (244.82 g, i.e. 1.28 mol) is gradually added at a temperature of 20° C. (reaction temperature maintained at this value by means of an ice-water bath placed under the reactor) to a solution of maleic anhydride (128.2 g, i.e. 1.307 mol) in toluene as solvent (442.5 g), over a period of 105 minutes. The reaction medium is then left at 23° C. for 15 hours. At the end of this time, the reaction medium is filtered through a sinter funnel of porosity 3 and a solution of the desired maleamic acid silane in toluene is thus recovered, which solution is used in the form in which it is obtained, to carry out the following process (d). This solution contains 0.157 mol of maleamic acid silane per 100 g of solution.

2. Preparation of Compound A Comprising a Polymer POS/1 of Imide Type by Carrying Out Process (d):

1st stage: ZnCl₂ (43.78 g, i.e. 0.3214 mol) is introduced into a 0.5-litre glass reactor equipped with a stirring system and an addition funnel and the solid is then heated at 80° C. for 1 hour 30 minutes under a reduced pressure of 3×10² Pa; the reactor is returned to atmospheric pressure, working under an argon atmosphere, and 91.45 g of the solution of maleamic acid silane (41.5 g, i.e. 0.143 mol) in toluene, obtained previously in point 1, are then added gradually;

2nd stage: the reaction mixture is brought to a temperature of 54° C. and hexamethyldisilazane (65.12 g, i.e. 0.403 mol) is then added gradually over a period of one hour; at the end of the addition, the temperature of the reaction medium is 82° C., and is maintained at this value for a further 1 hour 30 minutes;

3rd stage: N-methylmorpholine (20.14 g, i.e. 0.199 mol) is introduced into the reaction medium, followed by trimethylchlorosilane (21.49 g, i.e. 0.198 mol), working at a temperature of about −20° C.; the resulting reaction medium is left stirring for 15 hours, while allowing the temperature to rise slowly to room temperature (23° C.);

4th stage: the reaction medium obtained is filtered through a sinter funnel of porosity 3 containing 2 cm of silica, and the filtrate obtained is then devolatilized at 30° C. by establishing a reduced pressure of 10×10² Pa, to give a brown oil comprising the desired oligomer POS/1 of imide type. The said brown oil was subjected to proton NMR and silicon (²⁹Si) NMR analyses. The results of these analyses reveal that the reaction product obtained after process (d) contains:

62% by weight of polymer POS/1 of imide type in the form of an oligomer of average formula:

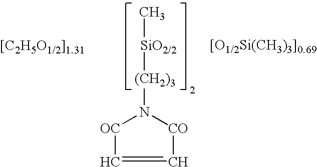

and 38% by weight of the organosilane of formula:

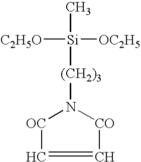

### EXAMPLE 2

This example illustrates the preparation of a coupling agent or compound A according to the invention, comprising another polymer POS/1 of imide type.

This other compound A is prepared by carrying out process (e) which was outlined above in the present specification, with N-[γ-propyl(methyldiethoxy)silane]maleamic acid as starting organosilane of formula (X).

1.- Preparation of the Starting Maleamic Acid Silane:

The process is performed in a 2-litre glass reactor equipped with a stirring system and an addition funnel. The γ-aminopropylsilane of formula (C₂H₅O)₂CH₃Si(CH₂)₃NH₂ (563 g, i.e. 2.944 mol) is gradually added at a temperature of 20-22° C. (reaction temperature maintained at this value by means of an ice-water bath placed under the reactor) to a solution of maleic anhydride (300.1 g, i.e. 3.062 mol) in toluene as solvent (1008 g), over a period of 2 hours. The reaction medium is then left at 23° C. for 15 hours. At the end of this time, the reaction medium is filtered through a sinter funnel of porosity 3 and a solution of desired maleamic acid silane in toluene is thus recovered, which solution is used in the form in which it is obtained to carry out the following process (e). This solution contains 0.157 mol of maleamic acid silane per 100 g of solution.

2.- Preparation of Compound A Comprising Another Polymer POS/1 of Imide Type by Carrying Out Process (e):

1st stage: ZnCl₂ (168.2 g, i.e. 1.2342 mol) is introduced into a 3-litre glass reactor equipped with a stirring system and an addition funnel, and the solid is then heated at 80° C. for 1 hour 30 minutes under a reduced pressure of 4×10² Pa; the reactor is then returned to atmospheric pressure, working under an argon atmosphere, and 365 cm³ of toluene are then added, followed by gradual addition of 704.8 g of the solution of maleamic acid silane (320 g, i.e. 1.107 mol) in toluene which was obtained previously in point 1;

2nd stage: the addition funnel is loaded with cyclic hexamethyltrisilazane (88.7 g, i.e. 0.404 mol) and 208 cm³ of toluene; the temperature of the reaction medium is 72° C. The cyclic hexamethyltrisilazane is then added gradually over a period of 2 hours 25 minutes; at the end of the addition, the orange-coloured organic solution obtained is heated to a temperature of 75° C. and is maintained at this temperature for 15 hours;

4th stage: the reaction medium is filtered through a “cardboard filter” and the toluene is then removed after devolatilization under reduced pressure.

A yellow oil is thus obtained, which was subjected to proton NMR and silicon (²⁹Si) NMR analyses. The results of these analyses reveal that the reaction product obtained after process (e) contains:

73.7% by weight of polymer POS/1 of imide type in the form of an oligomer of average formula:

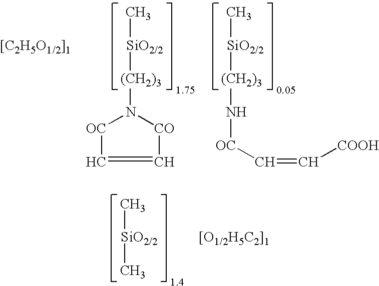

23.1% by weight of the organosilane of formula:

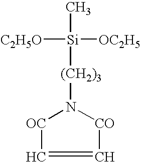

0.7% by weight of the organosilane of formula:

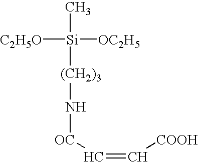

and 2.5% by weight of the cyclic monofunctional POS of average formula:

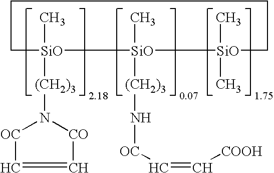

### EXAMPLE 3

This example illustrates the preparation of a coupling agent or compound A according to the invention, comprising a polymer POS/2 of acid type.

This compound A is prepared by carrying out a process (f) which was outlined above in the present specification, which consists in reacting an amino POS of formula (XV) with maleamic anhydride.

1.- Preparation of the Starting Amino POS:

γ-Aminopropylsilane of formula (C₂H₅O)₂CH₃Si(CH₂)₃NH₂ (858.1 g, i.e. 4.484 mol), an α,ω-dihydroxylated polydimethylsiloxane oil (346.51 g) with a viscosity of 50 mPa.s at 25° C. and a titre of 12% by weight of OH, water (46.92 g, i.e. 2.608 mol) and catalyst based on potassium siliconate (0.1059) are introduced into a 2-litre glass reactor fitted with a mechanical stirring system and an ascending condenser. The reaction medium is heated at 95° C. for 6 hours. At the end of this time, the reaction medium is left for 15 hours at room temperature (23° C.) and is then neutralized with 0.241 g of a mixture based on phosphoric acid and polydimethylsiloxane oligomers, working at 90° C. for 1 hour. The reaction medium obtained is then devolatilized, working at 180° C. and under a reduced pressure of 3×10² Pa, for 30 minutes.

The amino POS was subjected to proton and silicon NMR analyses. The results of these analyses reveal a mixture of linear (85 mol %) and cyclic (15 mol %) structures having the following average formulae:

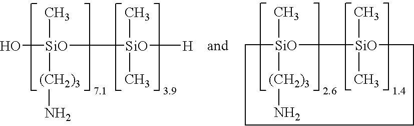

The amino POS thus obtained contains 0.5 mol of amine functions per 100 g of product.

2.- Preparation of Compound A Comprising a Polymer POS/2 of Acid Type by Carrying Out a Process (f):

A solution of maleic anhydride (30.67 g, i.e. 0.3128 mol) in CH₂Cl₂ as solvent (400 cm³) is introduced into a 1 l glass reactor fitted with a stirring system and an addition funnel, the temperature of the reaction medium is then lowered to 8° C. and the amino POS (62.11 g) is then added gradually over a period of 1 hour 15 minutes, while maintaining the temperature of the reaction medium at 8° C. during the addition. At the end of the addition, the reaction medium is left for 15 hours at room temperature (23° C.). The solvent is then removed under reduced pressure, working at a temperature which does not exceed 30° C.

An oil is thus obtained, which was subjected to proton NMR and silicon (²⁹Si) NMR analyses. The results of these analyses reveal that the reaction product obtained from process (f) contains:

91.3% by weight of the polymer POS/2 of acid type of average formula:

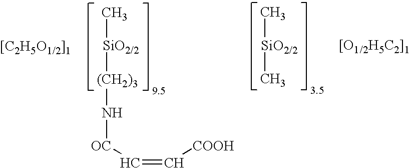

and 8.7% by weight of the cyclic monofunctional POS of average formula:

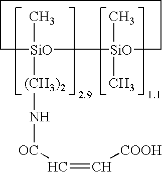

### EXAMPLE 4

This example illustrates the preparation of a coupling agent or compound A according to the invention, comprising a polymer POS/2 of ester type.

This compound A is prepared by carrying out the process (h) [with activation method (2j)] which was outlined above in the present specification.

1.- Alcoholysis of Maleic Anhydride:

Maleic anhydride (698.1 g, i.e. 7.12 mol) is introduced into a 2-litre four-necked reactor and is then melted by heating the reactor using an oil bath brought to 70° C. Once all of the anhydride has melted, methanol (221.4 g, i.e. 6.92 mol) is introduced via an addition funnel, with stirring. The medium is then left stirring for 20 hours at 23° C., after which it is devolatilized by establishing a reduced pressure of 10×10² Pa for 1 hour, and is finally filtered through filter paper. 786.9 g of maleic acid monomethyl ester of the formula below are thus recovered (yield of 86%):

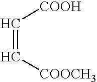

2.- Preparation of the Activated Ester Derivative According to Activation Method (2j):

N-Hydroxysuccinimide (39.20 g, i.e. 0.3406 mol), tetrahydrofuran as solvent (200 cm³) and maleic acid monomethyl ester (40.1 g, i.e. 0.3085 mol) are introduced into a 2-litre glass reactor equipped with a mechanical stirrer and an addition funnel. The reaction medium is stirred and dicyclohexylcarbodiimide (69.3 g, i.e. 0.3363 mol) is added gradually at room temperature (23° C.) over a period of 10 minutes. The medium becomes heterogeneous on account of the precipitation of dicyclohexylurea.

After a reaction time of 50 minutes, the reaction medium is filtered through a Buchner funnel and the filtrate is concentrated by evaporation at a temperature not exceeding 35° C. The residual reaction medium is left at a temperature of 4° C. for 15 hours and is then refiltered through a sinter funnel containing 10 cm of silica. The second filtrate obtained is completely devolatilized under reduced pressure to remove the remaining solvent, and the solid finally obtained is then recrystallized from a CH₂Cl₂/ethylenic ether mixture; the mother liquors from this recrystallization are recovered and concentrated, and a second recrystallization is carried out.

41 g (yield of 55%) of the activated ester derivative of the formula below are thus recovered:

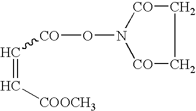

3.- Preparation of the Amino POS:

γ-Aminopropylsilane of formula: (C₂H₅O)₂CH₃Si(CH₂)₃NH₂ (1700.3 g, i.e. 8.9 mol) is introduced into a 4-litre glass reactor fitted with a mechanical stirrer and an ascending condenser. Water (1442.5 g, i.e. 80.13 mol) is added via an addition pump at a rate of 10 cm³/hour. The reaction is exothermic throughout the addition and the temperature is not regulated. After reaction for 3 hours, a water/ethanol mixture is removed under reduced pressure of 10×10¹ Pa, first at 40° C. and then at 70° C. to completely remove the ethanol, thus giving an intermediate amine oil.

350.24 g of the intermediate amine oil obtained from the preceding step, an α,ω-dihydroxylated polydimethylsiloxane (230.92 g) with a viscosity of 50 mPa.s at 25° C. and a titre of 12% by weight of OH, and catalyst based on potassium siliconate (0.0416 g) are introduced into another 1-litre reactor also fitted with a mechanical stirrer and a condenser. The reaction medium is heated at 90° C. for 6 hours. At the end of this time, the reaction medium is left for 15 hours at room temperature (23° C.) and is then neutralized with 0.0974 g of a mixture based on phosphoric acid and polydimethylsiloxane oligomers, working at 90° C. for 1 hour. The reaction medium obtained is filtered through a 0.5 μm microporous filter.

The amino POS obtained was subjected to proton and silicon NMR analyses. The results of these analyses reveal a mixture of linear (74 mol %) and cyclic (26 mol %) structures having the average formulae below:

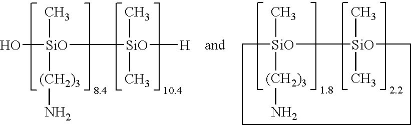

The POS thus obtained contains 0.51 amine function per 100 g of product.

4.- Preparation of Compound A Comprising a Polymer POS/2 of Ester Type by Coupling the Activated Ester Derivative with the Amino POS:

The activated ester derivative as prepared in point 2 above (39.83 g, i.e. 0.175 mol) is introduced into a four-necked reactor with 200 cm³ of CH₂Cl₂ as solvent. The amino POS as prepared in point 3 above (30.82 g) is dissolved in 200 cm³ of CH₂Cl₂ and the solution is then introduced into an addition funnel. The addition is carried out gradually over a period of 1 hour, onto a reaction medium which has been cooled beforehand to 5° C. on an ice-water bath.

Once the addition is complete, the reaction medium is reacted at room temperature (23° C.) for 15 hours. At the end of this time, the medium is transferred into a separating funnel and is then washed 4 times successively with water. The addition of saturated aqueous NaCl solution is necessary in order to help the phases to separate. The residual organic phase is recovered, dried over MgSO₄ and then filtered through filter paper and finally the solvent is removed under reduced pressure and at room temperature (23° C.).

An oil is thus obtained, which was subjected to proton NMR and silicon (²⁹Si) NMR analyses. The results of these analyses reveal that the reaction production obtained after process (h) contains:

94.8% by weight of polymer POS/2 of ester type of average formula:

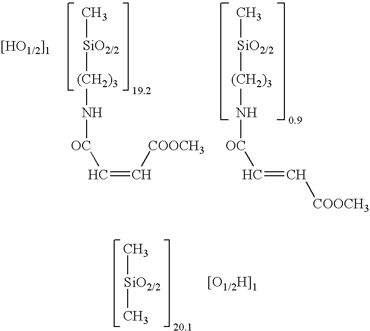

and 5.2% by weight of the cyclic monofunctional POS of average formula:

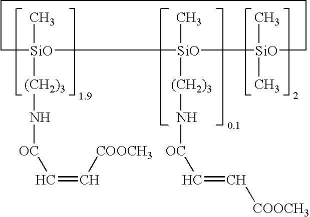

### EXAMPLES 5 TO 8

The aim of these examples is to show the performance qualities in terms of coupling (for white filler-isoprene elastomer coupling) of a compound A comprising a multifunctional POS (compound A_{POS}) which was defined above, firstly bearing at least one hydroxyl radical and/or at least one alkoxy radical, and secondly bearing at least one activated ethylenic double bond. These performance qualities are compared with those of a conventional coupling agent based on a TESPT silane.

6 isoprene elastomer compositions representative of shoe sole formulations are compared. These 6 compositions are identical except for the following differences:

composition No. 1 (control 1): absence of coupling agent;

composition No. 2 (control 2): coupling agent based on TESPT silane (4 pce);

composition No. 3 (Example 5): coupling agent or compound A, providing in the composition 1.86 pce of polymer POS/1 of imide type, prepared in Example 1;

composition No. 4 (Example 6): coupling agent or compound A providing in the composition 2.65 pce of polymer POS/1 of imide type, prepared in Example 2;

composition No. 5 (Example 7): coupling agent or compound A providing in the composition 4.66 pce of the polymer POS/2 of acid type, prepared in Example 3;

composition No. 6 (Example 8): coupling agent or compound A providing in the composition 5.02 pce of the polymer POS/2 of ester type, prepared in Example 4.

1) Constitution of the Isoprene Elastomer Compositions:

The compositions below, the constitution of which, expressed in parts by weight, is given in Table I given below, are prepared in a Brabender internal mixer:

TABLE 1

| | | Con- | Con- | Ex. | Ex. | Ex. | Ex. |
|---|---|---|---|---|---|---|---|
| Composition | | trol 1 | trol 2 | 5 | 6 | 7 | 8 |
| NR rubber | (1) | 85 | 85 | 85 | 85 | 85 | 85 |
| BR 1220 rubber | (2) | 15 | 15 | 15 | 15 | 15 | 15 |
| Silica | (3) | 50 | 50 | 50 | 50 | 50 | 50 |
| Zinc oxide | (4) | 5 | 5 | 5 | 5 | 5 | 5 |
| Stearic acid | (5) | 2 | 2 | 2 | 2 | 2 | 2 |
| TESPT silane | (6) | — | 4 | — | — | — | — |
| Compound A comprising | | — | — | 3 | — | — | — |
| the polymer POS/1 of | | | | | | | |
| imide type prepared in | | | | | | | |
| Example 1 | | | | | | | |
| Compound A comprising | | — | — | — | 3.6 | — | — |
| the polymer POS/1 of | | | | | | | |
| imide type prepared in | | | | | | | |
| Example 2 | | | | | | | |
| Compound A comprising | | — | — | | — | 5.1 | — |
| the polymer POS/2 of | | | | | | | |
| acid type prepared in | | | | | | | |
| Example 3 | | | | | | | |
| Compound A comprising | | — | — | | — | — | 5.3 |
| the polymer POS/2 of | | | | | | | |
| ester type prepared in | | | | | | | |
| Example 4 | | | | | | | |
| TBBS | (7) | 2 | 2 | 2 | 1 | 2 | 2 |
| DPG | (8) | 1.4 | 1.4 1.4 | 1.4 | 1.4 | 1.4 | |
| Sulphur | (9) | 1.7 | 1.7 1.7 | 1.7 | 1.7 | 1.7 | |

(1) Natural rubber, of Malaysian origin, sold by the company Safic-Alcan under the reference SMR 5L;
(2) Polybutadiene rubber with a high content of cis-1 ,4 addition products, sold by the company Shell;
(3) Zeosil 1165 MP silica, sold by the company Rhodia-Silices;
(4) and (5) vulcanization activators;
(6) Bis(3-triethoxysilylpropyl) tetrasulphide sold by the company Degussa under the name Si-69;
(7) N-tert-Butyl-2-benzothiazylSulpheflamide (vulcanization accelerator);
(8) Diphenylguanidine (vulcanization activator);
(9) Vulcanizing agent.

2) Preparation of the Compositions:

The various constituents are introduced, in order, at the times and temperatures given below, into a Brabender internal mixer:

| Time | Temperature | Constituents |
|---|---|---|
| 0 minute | 80° C. | NR rubber |
| 1 minute | 90° C. | BR rubber |
| 2 minutes | 100° C. | ⅔ silica + coupling agent |
| 4 minutes | 120° C. | ⅓ silica + stearic acid + zinc oxide |
| | | Discharge |
| 5 minutes | 140 to 150° C. | |

The discharge or sedimentation of the contents of the mixer takes place after 5 minutes. The temperature reached is approximately 145° C.

The mixture obtained is then introduced into a roll mill, maintained at 30° C., and the TBBS, the DPG and the sulphur are introduced. After homogenization, the final mixture is calendered in the form of sheets 2.5 to 3 mm thick.

3) Rheological Properties of the Compositions:

The measurements are taken on the compositions in raw form. The results regarding the rheology test which is carried out at 160° C. for 30 minutes using a Monsanto 100 S rheometer are given in Table II below.

According to this test, the test composition is placed in the test chamber adjusted to a temperature of 160° C., and the resistant torque, opposed by the composition, to an oscillation of low amplitude of a biconical rotor included in the test chamber is measured, the composition completely filling the chamber under consideration. From the curve of variation of the torque as a function of time, the following are determined: the minimum torque which reflects the viscosity of the composition at the temperature under consideration; the maximum torque and the delta-torque which reflect the degree of crosslinking entailed by the action of the vulcanization system; the time T-90 required to obtain a vulcanization state corresponding to 90% of the complete vulcanization (this time is taken as the vulcanization optimum); and the scorched time TS-2 corresponding to the time required for a 2-point increase above the minimum torque at the temperature under consideration (160° C.) and which reflects the time for which it is possible to use the raw mixtures at this temperature without any initiation of vulcanization taking place.

The results obtained are given in Table II.

TABLE II

| | Con- | Con- | Ex- | Ex- | Ex- | Ex- |
|---|---|---|---|---|---|---|
| | trol | trol | ample | ample | ample | ample |
| Monsanto rheology | 1 | 2 | 5 | 6 | 7 | 8 |
| Minimum torque | 27.1 | 15.3 | 18.2 | 15.7 | 12.2 | 17.4 |
| Maximum torque | 81.5 | 108.5 | 92.8 | 97.8 | 94.7 | 85.4 |
| Delta-torque | 54.4 | 93.2 | 74.6 | 82.1 | 82.5 | 68.1 |
| TS-2 (minutes) | 4 | 3.6 | 3.1 | 2.5 | 3.87 | 3.73 |
| TS-90 (minutes) | 7.4 | 7.33 | 6.4 | 5.69 | 7.15 | 6.8 |

4) Mechanical Properties of the Vulcanizates:

The measurements are taken on compositions uniformly vulcanized for 20 minutes at 160° C.

The properties measured and the results obtained are collated in Table III below:

TABLE III

| Mechanical properties | | Control 1 | Control 2 | Ex. 5 | Ex. 6 | Ex. 7 | Ex. 8 |
|---|---|---|---|---|---|---|---|
| 10% Modulus | (1) | 0.65 | 0.89 | 0.75 | 0.81 | 0.88 | 0.69 |
| 100% Modulus | (1) | 1.31 | 3.54 | 2.56 | 2.9 | 2.4 | 1.78 |
| 300% Modulus | (1) | 3.7 | 15.2 | 12.3 | 14.1 | 9.5 | 7 |
| Elongation at break | (1) | 810 | 370 | 480 | 400 | 530 | 680 |
| Breaking strength | (1) | 23.8 | 19 | 24 | 21 | 21.6 | 24 |
| Reinforcement indices: | | | | | | | |
| 300% M/100% M | | 2.8 | 4.3 | 4.8 | 4.9 | 4 | 3.9 |
| Shore A hardness | (2) | 65 | 74 | 70 | 70 | 69 | 68 |
| Abrasion resistance | (3) | 227 | 113 | 89 | 90 | 134 | 149 |

(1) The tensile tests are performed in accordance with the indications of NF T standard 46-002 with test pieces of H2 type. The 10%, 100% and 300% moduli and the breaking strength are expressed in MPa; the elongation at break is expressed in %.
(2) The measurement is taken according to the indications of ASTM standard D 3240. The value given is measured at 15 seconds.
(3) The measurement is taken according to the indications of NF T standard 46-012, using method 2 with a rotating sample holder. The value measured is the loss of substance (in mm³) on abrasion; the lower the value, the better the abrasion resistance.

It is found that, after curing, the compositions of Examples 5 to 8 show modulus values under high deformation (300% M) and reinforcement indices which are higher than those of the control mixture without coupling agent and which may be higher than those obtained with the TESPT silane (control 2).

It is also noted that all the mixtures mentioned show an abrasion resistance which is very substantially greater than that of control 1.

The improvement in these indicators is known to those skilled in the art as demonstrating a significant improvement in the white filler-elastomer coupling due to an incontestable coupling effect of the coupling agents introduced into the compositions of Examples 5 to 8.

It is pointed out most particularly that the coupling agent used in Example 6 (compound comprising the polymer POS/1 of imide type prepared in Example 2) leads to a particularly advantageous compromise of properties since it makes it possible simultaneously to obtain:

viscosities similar to those achieved with TESPT (control 2),

a 300% modulus which is quite close to that imparted by TESPT,

a reinforcement index which is substantially higher than that obtained with TESPT,

an excellent level of abrasion resistance, which is substantially better than that imparted by TESPT.

1. Use of an effective amount of a coupling agent consisting of a compound A bearing at least two functions, noted Y and X, which is graftable firstly onto the white filler by means of the function Y and secondly onto the elastomer by means of the function X;
as white filler-elastomer coupling agent in rubber compositions comprising:
(B) at least one elastomer of natural or synthetic rubber type;
(C) a white filler as reinforcing filler;
the said use being characterized in that:
the coupling agent is a compound A which comprises a multifunctional POS (compound A_{POS}) comprising, per molecule, and attached to silicon atoms, firstly, as function Y, at least one hydroxyl function and/or at least one hydrolysable function, and secondly, as function X, at least one group containing an activated ethylenic double bond;
the said coupling agent is incorporated into rubber compositions based on isoprene elastomer(s); and
the amount of the said coupling agent is determined so as to provide in the isoprene rubber composition at least 0.5 pce (parts by weight per 100 parts by weight of elastomer(s)) of POS (compound A_{POS}).

2. Use according to claim 1, characterized in that, as function(s) X, the coupling agent or compound A comprises at least one ethylenic double bond which is activated by at least one adjacent electron-withdrawing group chosen from radicals bearing at least one of the bonds C═O, C═C, C≡C, OH, OR(R alkyl), CN or OAr (Ar aryl), or bearing at least one sulphur and/or nitrogen atom or at least one halogen.

3. Use according to claim 2, characterized in that the adjacent electron-withdrawing group is chosen from acyl (—COR), carbonyl (>C═O), carboxyl (—COOH), carboxy ester (—COOR), carbamyl (—CO—NH₂; —CO—NH—R; —CO—N—R₂), alkoxy (—OR), aryloxy (—OAr), hydroxyl (—OH), alkenyl (—CH═CHR), alkynyl (—C≡CR), naphthyl (C₁₀H₇—) and phenyl (C₆H₅—) radicals and radicals bearing at least one sulphur (S) and/or nitrogen (N) atom or at least one halogen.

4. Use according to claim 3, characterized in that the adjacent electron-withdrawing group is a carbonyl (>C═O) group.

5. Use according to any one of claims 1 to 4, characterized in that, as function(s) Y, the coupling agent or compound A comprises a functionality which is chosen from at least one hydroxyl radical, at least one alkoxy radical of formula R¹O in which R¹ represents a linear or branched alkyl radical containing from 1 to 15 carbon atoms, and a mixture of hydroxyl and alkoxy radicals.

6. Use according to claim 5, characterized in that the functionality Y is chosen from at least one hydroxyl radical, at least one linear or branched alkoxy radical containing from 1 to 6 carbon atoms, and a mixture of hydroxyl and C₁-C₆ alkoxy radicals.

7. Use according to any one of claims 1 to 6, characterized in that the coupling agent is a compound A which comprises a multifunctional POS containing identical or different units of formula:
$$\begin{matrix}{( {R}^{2} )}_{a} {Y}_{b} {X}_{c} SiO & \\ & \frac{4 - ( a + b + c )}{2}\end{matrix} \qquad ( I )$$
in which:
(1) the symbols R², which may be identical or different, each represent a monovalent hydrocarbon-based group chosen from a linear or branched alkyl radical containing from 1 to 6 carbon atoms, a cycloalkyl radical containing from 5 to 8 carbon atoms and a phenyl radical;
(2) the symbols Y, which may be identical or different, each represent a hydroxyl or alkoxy R¹O function, in which R¹ has the general definition given above in claim 5;
(3) the symbols X, which may be identical or different, each represent a function bearing an activated ethylenic double bond chosen:
(3.1) from functions bearing an ethylenic double bond activated with at least one activating group having the definitions given above in any one of claims 2 to 4;
(4) the symbols a, b and c each represent integers or fractions chosen from:
a: 0, 1, 2 or 3;
b: 0, 1, 2 or 3;
c: 0 or 1;
the sum a+b+c being other than zero and ≦3;
(5) the content of units R¹¹SiO_{3/2} (units “T”) in which R¹¹ is chosen from the radicals corresponding to the definitions of R², Y and X, this content being expressed as the number, per molecule, of these units per 100 silicon atoms, is less than or equal to 30%
(6) the content of functions Y, expressed as the number, per molecule, of functions Y per 100 silicon atoms, is at least 0.8%;
(7) the content of functions X, expressed as the number, per molecule, of functions X per 100 silicon atoms, is at least 0.4%.

8. Use according to claim 7, characterized in that, in formula (I), point (3), the symbols X, which may be identical or different, each represent a function bearing an activated ethylenic double bond chosen:
(3.2) from the radicals of formulae (X/a), (X/b) and (X/c) below, and mixtures thereof: 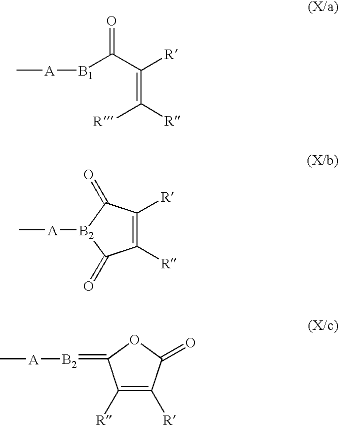
in which formulae:
B₁ is O, NH, N-alkyl, N-phenyl, S, CH₂, CH-alkyl or CH-phenyl;
B₂ is N, CH, C-alkyl or C-phenyl;
the radicals R′, R″ and R, which may be identical or different, each represent a hydrogen atom, a halogen atom, a cyano radical, a linear or branched alkyl radical containing from 1 to 6 carbon atoms or a phenyl radical, the radicals R″ and/or R also possibly representing a monovalent COOH group or a derived group such as an ester or amide;
the divalent radical A is intended to provide the bonding with the polysiloxane chain and consists of a saturated or unsaturated divalent hydrocarbon-based radical which may comprise one or more hetero atoms such as oxygen and nitrogen, containing from 1 to 18 carbon atoms.

9. Use according to claims 7 and 8, characterized in that, in formula (I), point (3), the symbols X, which may be identical or different, each represent a function bearing an activated ethylenic double bond chosen:
(3.3) from radicals having the formulae (II/1) to (II/5) below, and mixtures thereof: 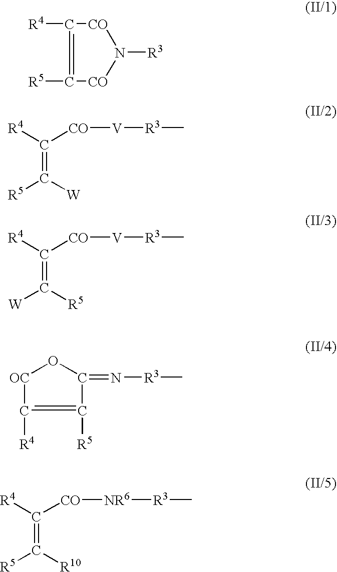
in which formulae:
the symbol V represents a divalent radical —O— or —NR⁶—;
the symbol W represents a monovalent group COOR⁷ or a monovalent group CONR⁸R⁹;
R³ is a linear or branched divalent alkylene radical containing from 1 to carbon atoms, the free valency of which is borne by a carbon atom and is linked to a silicon atom, the said radical R³ possibly being interrupted in the alkylene chain with at least one hetero atom (such as oxygen and nitrogen) or at least one divalent group comprising at least one hetero atom (such as oxygen and nitrogen), and in particular with at least one divalent residue of general formula ^{V1}residue^{V2} chosen from: —O—, —CO—, —CO—O—, —COO-cyclohexylene (optionally substituted with an OH radical)-, —O-alkylene (linear or branched C₂-C₆, optionally substituted with an OH or COOH radical)-, —O—CO-alkylene (linear or branched C₂-C₆, optionally substituted with an OH or COOH radical)-, —CO—NH—, —O—CO—NH— and —NH-alkylene (linear or branched C₂-C₆)—CO—NH—; R³ also represents a divalent aromatic radical of general formula ^{V1}residue^{V2} chosen from: -(ortho, meta or para)phenylene(linear or branched C₂-C₆)alkylene-, -(ortho, meta or para)phenylene-O-(linear or branched C₂-C₆)alkylene-, -(linear or branched C₂-C₆)alkylene-(ortho, meta or para)phenylene(linear or branched C₁-C₆)alkylene-, and -(linear or branched C₂-C₆)alkylene(ortho, meta or para)phenylene-O-(linear or branched C₁-C₆)alkylene-; preferably, the symbol R³ represents an alkylene radical which corresponds to the following formulae: —(CH₂)₂—, —(CH₂)₃—, —(CH₂)₄—, —CH₂—CH(CH₃)—, —(CH₂)₂—CH(CH₃)—CH₂—, —(CH₂)₃—O—(CH₂)₃—, —(CH₂)₃—O—CH₂—CH(CH₃)—CH₂—, —(CH₂)₃—O—CH₂CH(OH)—CH₂—; more preferably, R³ is a —(CH₂)₂— or —(CH₂)₃-radical; with the specific detail that, in the preceding definitions of R³, when the divalent residues and radicals mentioned are not symmetrical, they may be positioned with the valency v1 to the left and the valency v2 to the right, or vice versa with the valency v2 to the left and the valency v1 to the right;
the symbols R⁴ and R⁵, which may be identical or different, each represent a hydrogen atom, a halogen atom, a cyano radical, a linear or branched alkyl radical containing from 1 to 6 carbon atoms or a phenyl radical, R⁵ also possibly representing a monovalent group COOR⁷;
the symbols R⁶, R⁷, R⁸, R⁹ and R¹⁰, which may be identical or different, each represent a hydrogen atom, a linear or branched alkyl radical containing from 1 to 6 carbon atoms or a phenyl radical, the symbols R⁸ and R⁹ also possibly forming, together with the nitrogen atom to which they are attached, a single saturated ring containing from 3 to 8 carbon atoms in the ring.

10. Use according to claim 9, characterized in that the functions X are chosen from the radicals of formulae (II/1) to (II/5) and mixtures thereof, in which:
the symbol V is a radical —O— or —NR⁶— in which R⁶ has the preferred definition given below;
the symbol W is a group COOR⁷ or a group CONR⁸R⁹ in which the radicals R⁷, R⁸ and R⁹ have the preferred definitions given below;
the symbol R³ represents an alkylene radical which corresponds to the following formulae: —(CH₂)₂—, —(CH₂)₃—, —(CH₂)₄—, —CH₂—CH(CH₃)—, —(CH₂)₂—CH(CH₃)—CH₂—, —(CH₂)₃—O—(CH₂)₃—, —(CH₂)₃—O—CH₂—CH(CH₃)—CH₂—, —(CH₂)₃—O—CH₂CH(OH)—CH₂—;
the symbols R⁴ and R⁵ are chosen from a hydrogen atom, a chlorine atom and methyl, ethyl, n-propyl and n-butyl radicals, R⁵ also possibly representing a group COOR⁷ in which the radical R⁷ has the preferred definition given below;
the symbols R⁶, R⁷, R⁸, R⁹ and R¹⁰ are chosen from a hydrogen atom and methyl, ethyl, n-propyl and n-butyl radicals, the symbols R⁸ and R⁹ also possibly forming, together with the nitrogen atom, a pyrrolidinyl or piperidyl ring.

11. Use according to any one of claims 7 to 10, characterized in that, in formula (I):
(1) the symbols R² are chosen from methyl, ethyl, n-propyl, isopropyl, n-butyl, n-pentyl, cyclohexyl and phenyl radicals;
(2) the symbols Y each represent a hydroxyl function or an alkoxy function R¹O in which R¹ has the preferred definition given above in claim 6;
(5) the content of units “T” is less than or equal to 20%;
(6) the content of functions Y is in the range from 1% to 100%;
(7) the content of functions X is in the range from 0.8% to 100%.

12. Use according to any one of claims 7 to 11, characterized in that the coupling agent is a compound A which comprises a multifunctional POS chosen from:
POSs which are essentially linear and have the average formula below: 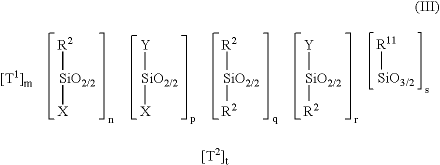
in which:
(1′) the symbols T¹ are chosen from the units HO_{1/2} and R¹O_{1/2}, in which the radical R¹ is as defined above;
(2′) the symbols T², which may be identical to or different from the symbols T¹, are chosen from the units HO_{1/2} and R¹O_{1/2} and the unit (R²)₃SiO_{1/2}, in which the radicals R¹ and R² are as defined above in points (2) and (1) regarding formula (I);
(3′) the symbols R², X and Y are as defined above in points (1), (3) [taken in its branches (3.1), (3.2) or (3.3)] and (2) regarding formula (I);
(4′) the symbols R¹¹ are chosen from the radicals corresponding to the definitions of R², X and Y;
(5′) the symbols m, n, p, q, r, s and t each represent integers or fractions which satisfy the following cumulative conditions:
m and t are each numbers that are always other than zero, the sum of which is equal to 2+s,
n is in the range from 0 to 100,
p is in the range from 0 to 100,
q is in the range from 0 to 100,
r is in the range from 0 to 100,
s is in the range from 0 to 75,
when n=0, p is always a number other than 0 and when p=0, n is always a number other than zero,
the sum n+p+q+r+s+t giving the total number of silicon atoms is in the range from 2 to 250,
the ratio 100s/(n+p+q+r+s+t) giving the content of units “T” is ≦30,
the ratio 100(m+p+r+s [when R¹¹=Y]+t)/(n+p+q+r+s+t) giving the content of functions Y is ≧1,
the ratio 100(n+p+s [when R¹¹=X])/(n+p+q+r+s+t) giving the content of functions X is ≧1;
POSs which are cyclic and have the average formula below: 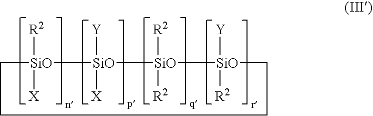
in which:
(3) the symbols R², X and Y are as defined above in points (1), (3) [taken in its branches (3.1), (3.2) or (3.3)] and (2) regarding formula (I);
(5) the symbols n′, p′, q′ and r′ each represent integers or fractions which satisfy the following cumulative conditions:
n′ is in the range from 0 to 9,
p′ is in the range from 0 to 9,
when n′=0, p′ is at least equal to 1,
when p′=0, n′ is at least equal to 1 and r′ is also at least equal to 1,
q′ is in the range from 0 to 9,
r′ is in the range from 0 to 2,
the sum n′+p′+q′+r′ is in the range from 3 to 10,
the ratio 100(p′+r′)/(n′+p′+q′+r′) giving the content of function Y ranges from 4 to 100,
the ratio 100(n′+p′)/(n′+p′+q′+r′) giving the content of functions X ranges from 10 to 100;
and mixtures of the POSs of formulae (III) and (III′).

13. Use according to claim 12, characterized in that the coupling agent is a compound A which comprises a multifunctional POS chosen from the essentially linear oligomers and polymers POS/1 which correspond to formula (III) in which:
(1″) the symbols T¹ are defined as given above in point (1′);
(2″) the symbols T² are defined as given above in point (2′);
(3″)
the functions X, which may be identical or different, are chosen from the radicals of formulae (II/1), (II/2) and (II/3), and mixtures thereof, with the following conditions according to which:
in the formulae (II/2) and (II/3), the symbol V=—NR⁶— in which R⁶=H, R⁵ is other than a group COOR⁷ and the symbol W=COOR⁷ in which R⁷=H,
at least one of the functions X corresponds to the formula (II/1),
when, where appropriate, there is a mixture of function(s) X of formula (II/1) with functions X of formulae (II/2) and/or (II/3), the mole fraction of functions X of formulae (II/2) and/or (II/3) in all of the functions X is on average less than or equal to 12 mol %,
the symbols R³, R⁴ and R⁵ (other than a group COOR⁷) are as defined above in point (3.3) regarding formula (I);
the symbols R² and Y are as defined above in points (1) and (2) regarding formula (I);
(4″) the symbols R¹ are chosen from the radicals R², the functions X in accordance with point (3″) and the functions Y;
(5″) the symbols m, n, p, q, r, s and t satisfy the following cumulative conditions:
m+t=2+s,
n is in the range from 0 to 50,
p is in the range from 0 to 20,
when n=0, p is at least equal to 1 and when p=0, n is at least equal to 1,
q is in the range from 0 to 48,
r is in the range from 0 to 10,
s is in the range from 0 to 1,
the sum n+p+q+r+s+t giving the total number of silicon atoms is in the range from 2 to 50,
the ratio 100s/(n+p+q+r+s+t) giving the content of units “T” is ≦10,
the ratio 100(m+p+r+s [when R¹¹=Y]+t)/(n+p+q+r+s+t) giving the content of functions Y ranges from 4 to 100,
the ratio 100(n+p+s [when R¹¹=X])/(n+p+q+r+s+t) giving the content of functions X ranges from 10 to 100.

14. Use according to claim 12, characterized in that the coupling agent is a compound A which comprises a multifunctional POS chosen from the essentially linear oligomers and polymers POS/2 which correspond to formula (III) in which:
(1) the symbols T¹ are defined as given above in point (1′);
(2) the symbols T², which may be identical to or different from the symbols T¹, are chosen from the unit HO_{1/2} and the unit R¹O_{1/2} as defined above in point (1′);
(3) the functions X, which may be identical or different, are chosen from:
either the radicals of formulae (II/2) and (II/3) and mixtures thereof, in which:
firstly, the symbol V=—NR⁶—, R⁵ is other than a group COOR⁷ and the symbol W=COOR⁷ in which R⁷=H, and
secondly, the symbols R³, R⁴, R⁵ (other than a group COOR⁷) and R⁶ are chosen as given above in point (3.3) regarding formula (I),
(in this case, the polymer will then be referred to for short as a polymer POS/2 of acid type),
or the radicals of formulae (II/2) and (II/3) and mixtures thereof, in which:
firstly, the symbol V=—NR⁶—, R⁵ is other than a group COOR⁷ and the symbol W=COOR⁷ in which R⁷, which is other than H, is a radical as defined above in point (3.3) regarding formula (I), and
secondly, the symbols R³, R⁴, R⁵ (other than a group COOR⁷) and R⁶ are chosen as given above in point (3.3) regarding formula (I),
(in this case, the polymer will then be referred to for short as a polymer POS/2 of ester type),
the symbols R² and Y are as defined above in points (1) and (2) regarding formula (I);
(4) the symbols R¹¹ are chosen from the radicals R², the functions X in accordance with point (3) and the functions Y;
(5) the symbols m, n, p, q, r, s and t satisfy the following cumulative conditions:
m+t=2+s,
n is in the range from 0 to 50,
p is in the range from 0 to 20,
when n=0, p is at least equal to 1 and when p=0, n is at least equal to 1,
q is in the range from 0 to 48,
r is in the range from 0 to 10,
s is in the range from 0 to 1,
the sum n+p+q+r+s giving the total number of silicon atoms is in the range from more than 2 to 50,
the ratio 100s/(n+p+q+r+s) giving the content of units “T” is ≦10,
the ratio 100(m+p+r+s [when R¹¹=Y]+t)/(n+p+q+r+s) giving the content of functions Y ranges from 4 to 100,
the ratio 100(n+p+s [when R¹¹=X])/(n+p+q+r+s) giving the content of functions X ranges from 10 to 100.

15. Elastomer compositions, characterized in that they comprise:
(B) at least one isoprene elastomer,
(C) a white reinforcing filler, and
(A) a suitable amount of coupling agent consisting of compound A comprising the multifunctional POS which has been defined above in any one of claims 1 to 14, firstly bearing at least one hydroxyl radical and/or at least one hydrolysable radical, and secondly bearing at least one activated ethylenic double bond (or compound A_{POS}), the said suitable amount being determined so as to provide in the isoprene rubber composition at least 0.5 pce of compound A_{POS}.

16. Compositions according to claim 15, characterized in that they comprise (the parts are given on a weight basis):
per 100 parts of isoprene elastomer(s) or compound B,
from 10 to 150 parts of white filler or compound C,
an amount of coupling agent or compound A which provides in the composition from 0.5 to 15 parts of compound A_{POS}.

17. Compositions according to claim 16, characterized in that they comprise:
per 100 parts of isoprene elastomer(s) or compound B,
from 30 to 100 parts of white filler or compound C,
an amount of coupling agent or compound A which provides in the composition from 0.8 to 10 parts of compound A_{POS}.

18. Composition according to any one of claims 15 to 17, characterized in that the isoprene elastomer(s) or compound B is (are) chosen from:
(1) synthetic polyisoprenes obtained by homopolymerization of isoprene or 2-methyl-1,3-butadiene;
(2) synthetic polyisoprenes obtained by copolymerization of isoprene with one or more ethylenically unsaturated monomers chosen from:
(2.1) conjugated diene monomers, other than isoprene, containing from 4 to 22 carbon atoms;
(2.2) vinylaromatic monomers containing from 8 to 20 carbon atoms;
(2.3) vinylic nitrile monomers containing from 3 to 12 carbon atoms;
(2.4) acrylic ester monomers derived from acrylic acid or methacrylic acid with alkanols containing from 1 to 12 carbon atoms;
(2.5) a mixture of several of the abovementioned monomers (2.1) to (2.4) together; the polyisoprene copolymers containing between 99% and 20% by weight of isoprene units and between 1% and 80% by weight of diene, vinylaromatic, vinylic nitrile and/or acrylic ester units;
(3) natural rubber;
(4) copolymers obtained by copolymerization of isobutene and isoprene (butyl rubber), as well as the halogenated versions of these copolymers;
(5) a mixture of several of the abovementioned elastomers (1) to (4) together;
(6) a mixture containing a major amount of abovementioned elastomer (1) or (3) and a minor amount of one or more diene elastomers other than isoprene elastomers.

19. Compositions according to claim 18, characterized in that use is made of one or more isoprene elastomer(s) chosen from: (1) synthetic polyisoprene homopolymers; (2) synthetic polyisoprene copolymers consisting of poly(isoprene-butadiene), poly(isoprene-styrene) and poly(isoprene-butadiene-styrene); (3) natural rubber; (4) butyl rubber; (5) a mixture of the above-mentioned elastomers (1) to (4) together; (6) a mixture containing a major amount of abovementioned elastomer (1) or (3) and a minor amount of diene elastomer other than an isoprene elastomer, consisting of polybutadiene, polychloroprene, poly(butadiene-styrene) and poly(butadiene-acrylonitrile).

20. Compositions according to any one of claims 15 to 19, characterized in that the white reinforcing filler or compound C consists of silica, alumina or a mixture of these two species.

21. Compositions according to claim 20, characterized in that:
the silica is a conventional or highly dispersible combustion silica with, in particular, a BET specific surface ≦450 m²/g,
the alumina is a highly dispersible alumina with, in particular, a BET specific surface ranging from 30 to 400 m²/g and a high content of Al—OH reactive surface function.

22. Compositions according to any one of claims 15 to 21, characterized in that, when they contain as coupling agent a compound A comprising a multifunctional POS bearing function(s) X chosen from the radicals of formulae (II/2), (II/3), (II/4) and/or (II/5), they then also contain at least one coupling activator.

23. Compositions according to claim 22, characterized in that the coupling activator is a free-radical initiator of the thermal initiation type, used in a low proportion of not more than 1 part by weight per 100 parts by weight of elastomer(s).

24. Compositions according to claim 22 or 23, characterized in that the coupling activator(s) is (are) chosen from the group consisting of peroxides, hydroperoxides, azido compounds, bis(azo) compounds, peracids and peresters, and a mixture of two or more than two of these compounds.

25. Compositions according to any one of claims 15 to 24, characterized in that they also contain all or some of the other auxiliary constituents and additives usually used in the field of elastomer rubber compositions, the said other constituents and additives comprising:
as regards the vulcanization system:
vulcanizing agents chosen from sulphur and sulphur-donating compounds;
vulcanization accelerators;
vulcanization activators;
as regards other additive(s):
a conventional reinforcing filler such as carbon black (in this case, the white reinforcing filler used constitutes more than 50% of the total weight of white reinforcing filler+carbon black);
a conventional white filler which provides little or no reinforcement;
antioxidants;
anti-ozonizers;
plasticizers and processing adjuvants.

26. Process for preparing the isoprene elastomer compositions according to any one of claims 15 to 25, characterized in that:
all the constituents required with the general exception of the vulcanizing agent(s) and, optionally, the vulcanization accelerator(s) and/or the vulcanization activator(s), are introduced into and blended in a common internal mixer, in one or two steps, working at a temperature ranging from 80° C. to 200° C.;
and the mixture thus obtained is then taken up in an external mixer and the vulcanizing agent(s) is (are) then added thereto, and, optionally, the vulcanization accelerator(s) and/or the vulcanization activator(s), working at a lower temperature, below 120° C.

27. Elastomer articles, characterized in that they have a body comprising a composition according to any one of claims 15 to 25.

28. Articles according to claim 27, characterized in that they consist of engine supports, shoe soles, cable-car rollers, seals for household electrical appliances and cable sheaths.
